(19) United States
(12) Patent Application Publication
(10) Pub. No.: US 2024/0241769 A1
(43) Pub. Date: Jul. 18, 2024

(54) SYSTEM FOR SECURE AND RELIABLE NODE LIFECYCLE IN ELASTIC WORKLOADS

(71) Applicants: Ned M. Smith, Beaverton, OR (US); Kshitij Arun Doshi, Tempe, AZ (US); Sunil Cheruvu, Tempe, AZ (US)

(72) Inventors: Ned M. Smith, Beaverton, OR (US); Kshitij Arun Doshi, Tempe, AZ (US); Sunil Cheruvu, Tempe, AZ (US)

(21) Appl. No.: 18/617,321

(22) Filed: Mar. 26, 2024

Related U.S. Application Data
(60) Provisional application No. 63/456,310, filed on Mar. 31, 2023.

(51) Int. Cl. G06F 9/50; G06F 21/54

(52) U.S. Cl. CPC G06F 9/5077; G06F 9/505; G06F 21/54

(57) ABSTRACT

Various systems and methods for providing secure and reliable node lifecycle in elastic workloads are described here. A compute node may be configured to: receive data describing a first elastic workload of the plurality of elastic workloads, the first elastic workload to execute on a first virtual execution environment, the first virtual execution environment associated with a first security context; determine a common resource that is used by the plurality of elastic workloads; store the common resource in a memory accessible by the first virtual execution environment; and execute the first elastic workload, wherein the first elastic workload has access to the common resource, and wherein the plurality of elastic workloads is executed in isolation from one another based on respective security contexts.

### PRIORITY CLAIM

This application claims the benefit of priority to U.S. Provisional Patent Application No. 63/456,310, filed Mar. 31, 2023, and titled “CLOUD TO EDGE SECURITY”, which is incorporated herein by reference in its entirety.

### BACKGROUND

Edge computing, at a general level, refers to the transition of compute and storage resources closer to endpoint devices (e.g., consumer computing devices, user equipment, etc.), in order to optimize total cost of ownership, reduce application latency, improve service capabilities, and improve compliance with compute security or data privacy requirements. Edge computing may, in some scenarios, provide a cloud-like distributed service that offers orchestration and management for applications among many types of storage and compute resources.

Some implementations of edge computing have been referred to as the “edge cloud” or the “fog,” as powerful computing resources previously available only in large remote data centers are moved closer to endpoints and made available for use by consumers at the “edge” of the network. The use of edge computing, and the many flavors of distributed or centralized cloud computing, have led to a variety of technical issues involving security, reliability, and resource usage.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating a trusted cloud-to-edge services framework, according to an example;

FIG. 2 is a block diagram illustrating the components of a Container-as-a-Service layer, according to an example;

FIG. 3 is a block diagram illustrating the components of a Platform-as-a-Service layer, according to an example;

FIG. 4 is a block diagram illustrating the components of an Infrastructure-as-a-Service layer, according to an example;

FIG. 5 is a block diagram illustrating various Infrastructure-as-a-Service layers and trust management capabilities, according to an example;

FIG. 6 is a block diagram illustrating a workflow of a workload, according to an example;

FIG. 7 is a block diagram illustrating a method of binding a workload to a procedure, according to an example;

FIG. 8 is a block diagram illustrating an elastic workload distribution plan involving a workload distribution manager interacting with pod managers, according to an example;

FIG. 9 is a block diagram illustrating an elastic workload update manager, according to an example;

FIG. 10 is a diagram illustrating trust coordination, according to an example;

FIG. 11 illustrates approaches and the advancement to a trust coordination framework, according to an example;

FIG. 12 is a diagram illustrating interoperability of the trust coordination service, according to an example;

FIG. 13 is a block diagram illustrating a general hierarchy of classes and attributes, according to an example;

FIG. 14 is a block diagram illustrating a specific hierarchy of classes and attributes, according to an example;

FIG. 15 is a block diagram illustrating a trust coordination framework architecture, according to an example;

FIG. 16 is a block diagram illustrating high-level operations in a trust coordination framework architecture, according to an example;

FIG. 17 is a block diagram illustrating state transitions of trustworthiness attributes, according to an example;

FIGS. 18-20 are swim lane diagrams illustrating interactions between components of a trust coordination framework architecture, according to various examples;

FIG. 21 is a block diagram illustrating a cloud-edge cluster, according to an example;

FIG. 22 is a block diagram illustrating a cloud-edge cluster after provisioning a distributed workload, according to an example;

FIG. 23 is a diagram illustrating an operating environment, according to an example;

FIG. 24 is a flowchart illustrating a process for fast provisioning and paging of isolated execution environments with tenant-specific security contexts;

FIG. 25 is a block diagram illustrating an infrastructure node, according to an example;

FIG. 26 illustrates security, trust, and resiliency functions, according to examples;

FIG. 27 is a flowchart illustrating a method for security, trust, and resiliency in elastic workloads, according to an example;

FIG. 28 illustrates an overview of an edge cloud configuration for edge computing, according to an example;

FIG. 29 illustrates deployment and orchestration for virtual edge configurations across an edge-computing system operated among multiple edge nodes and multiple tenants, according to an example;

FIG. 30 illustrates a vehicle compute and communication use case involving mobile access to applications in an edge-computing system, according to an example;

FIG. 31 illustrates a block diagram depicting deployment and communications among several Internet of Things (IOT) devices, according to an example;

FIG. 32 illustrates an overview of layers of distributed compute deployed among an edge computing system, according to an example;

FIG. 33 illustrates an overview of example components deployed at a compute node system, according to an example;

FIG. 34 illustrates a further overview of example components within a computing device, according to an example; and

FIG. 35 illustrates a software distribution platform to distribute software instructions and derivatives, according to an example.

### DETAILED DESCRIPTION

In the following description, methods, configurations, and related apparatuses are disclosed for implementation in a cloud-to-edge (C2E) framework. As used herein, “cloud-to-edge” generally refers to functionality to move workloads and capabilities that were traditionally located in a cloud computing setting towards distributed edge computing locations. Such functionality is particularly applicable to the deployment and execution of elastic workloads (WLs), which involve workloads that are distributed across multiple nodes, migrated, and dynamically coalesced.

Edge computing has introduced scenarios involving elastic workloads where a traditional monolithic workload, which may run on a single Edge node, may be decomposed into two or more sub-workloads that are distributed across multiple Edge nodes. The distributed workload may be partially or fully consolidated or decomposed even further to accommodate the changing resource dynamics of edge-cloud deployments for both stationary and mobile users and user equipment, or stationary and mobile edge nodes. These dynamics create an environment for elastic edge computing capabilities that include dynamic binding of workloads, resources, and compute.

### Trusted Cloud-to-Edge Framework

The use of elastic WLs is designed to provide flexibility to accommodate distribution and dynamism inherent in edge computing. A dynamic C2E framework is needed to ensure that trust within a complex elastic WL infrastructure is preserved throughout the many types of WL configurations and use cases.

Existing container-as-a-service (CaaS), platform-as-a-service (PaaS), and infrastructure-as-a-service (IaaS) capabilities expect that trust is established statically at an initial deployment of a WL, and such capabilities generally will not re-evaluate trust during WL execution. The dynamics of an elastic WL in an C2E deployment, however, change the WL from being a monolithic WL to a distributed WL having dynamic properties that distribute the WL processing across multiple nodes. This is further complicated because nodes may dynamically migrate to other hosting environments at lower framework layers, resulting in broken trust semantics.

The systems and methods described herein implement an elastic WL framework with security and trust capabilities at operational layers involving workload execution environments (e.g., containers, virtual machines, etc.), platforms, and infrastructure, and these layers' associated services (Container-as-a-Service (CaaS), Platform-as-a-Service (PaaS), and Infrastructure-as-a-Service (IaaS)). The following systems and methods introduce a Trust Binding Manager to actively monitor and apply trust bindings between the artifacts at respective layers that require consistent trust properties, while responding to dynamic conditions that otherwise will break trust properties. This enables elastic WL frameworks to establish and preserve intended trust properties of a WL throughout the WL execution and lifecycle despite the occurrence of dynamic changes in resources, location, and data sources/sinks.

A trusted C2E services framework for elastic workloads is adapted as follows to ensure various “anything-as-a-service” (X-aaS) capabilities in a services framework. This is used to establish and maintain trust within the respective framework layers, e.g., CaaS, PaaS, and IaaS, and between C2E framework layering, e.g., CaaS to PaaS, and PaaS to IaaS. The Trust Binding Manager component is used to establish and maintain trust properties for an elastic WL that is implemented using a trusted C2E framework. The C2E framework integrates a Trust Binding Manager component that enables creation, simulation, deployment, and maintenance of trusted elastic WLs following a WL lifecycle.

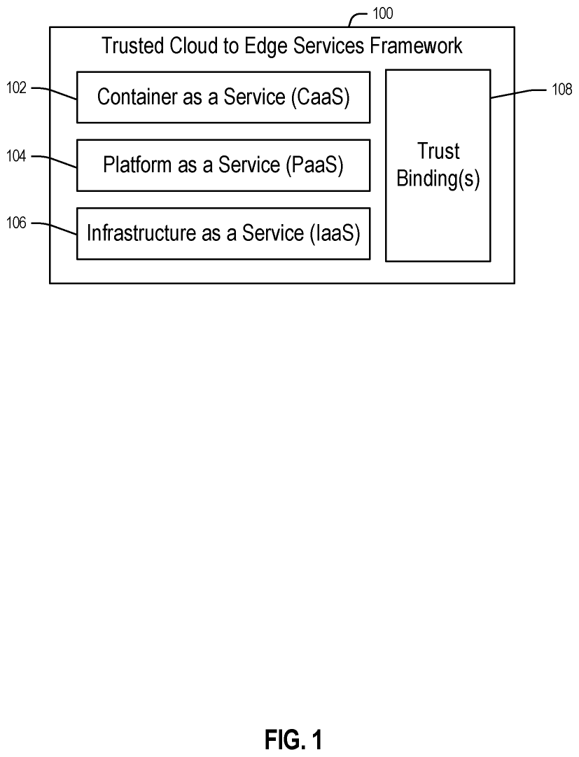

FIG. 1 is a block diagram illustrating an example of a trusted cloud-to-edge (C2E) services framework 100, according to an example. The trusted C2E services framework 100 includes a Container-as-a-Service (CaaS) layer 102, a Platform-as-a-Service (PaaS) layer 104, and an Infrastructure-as-a-Service (IaaS) layer 106, which are managed by using trust bindings 108.

The CaaS layer 102 creates a uniform abstraction for describing a workload that is independent of a particular platform. A distributed WL may partition the WL into logical sub-workloads that are related by a workflow model where the partial results from one sub-workload may be input to another sub-workload. The workflow may divide WL computations into execution operations that are in a particular sequence or in a particular concurrence. An individual sub-workload should have the same trust semantics as the monolithic WL. Monolithic WL trust may be established as part of an SLA (service level agreement) between the WL tenant and a WL service provider. Elastic WL execution may result in a distributed WL having multiple sub-workloads hosted by many nodes. The WL partitioning and execution workflow may introduce challenges to trust where the expected trust agreed to initially as part of an SLA agreement may disappear due to differences in platform and infrastructure options introduced by PaaS and IaaS framework layers.

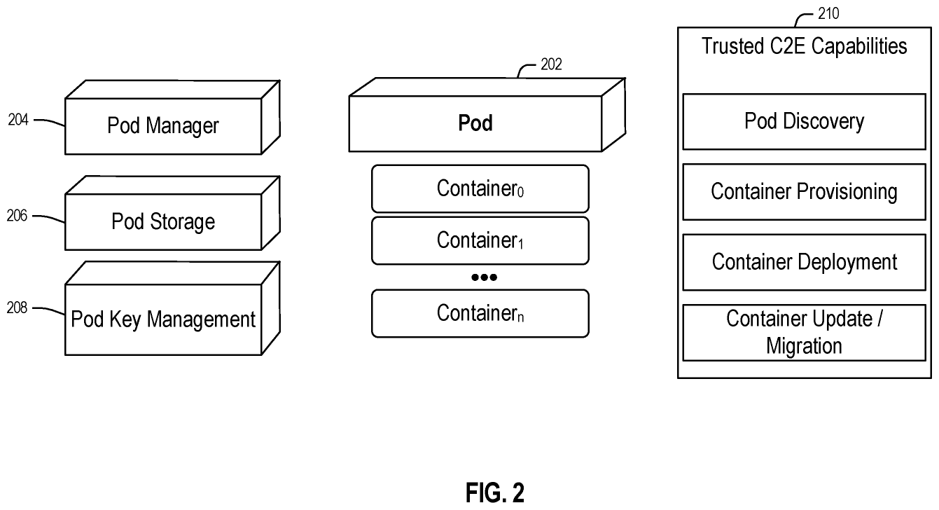

FIG. 2 is a block diagram illustrating the components of an example CaaS layer (e.g., corresponding to layer 102), according to an example. Here, a pod 202 is used to deploy multiple containers (labeled as container 0 to container n). Functionality used in the CaaS layer includes a pod manager 204, pod storage 206, and pod key management 208. The features discussed herein introduce the use of trusted C2E capabilities 210 for the CaaS layer, which include but are not limited to: pod discovery; container provisioning; container deployment; and container update or migration.

Returning to FIG. 1, the PaaS layer 104 creates a uniform platform abstraction that facilitates workload deployment where the sub-workload fragments of a distributed workload execute within one or more virtual and physical platform environments. The PaaS layer 104 abstraction hides hardware, system software, and cloud platform specific artifacts so that the workload designer does not need to adapt the workload to differences found at lower layers. The PaaS layer 104 abstraction also hides trust properties inherent to lower layers resulting in workloads that ignore the risks associated with untrusted hosting environments. In general, PaaS may depend on additional infrastructure layers that may themselves have layer abstractions and packaged as services (e.g., IaaS, hardware-as-a-service (HWaaS), etc.). Workload designers may not be aware of the various deployment options available at infrastructure layers. The services ecosystem may outsource some or all of workload deployment to a services abstraction. Consequently, workload security policies may need to be adapted, translated, and negotiated to the specific security postures at respective infrastructure layers and with respective service providers.

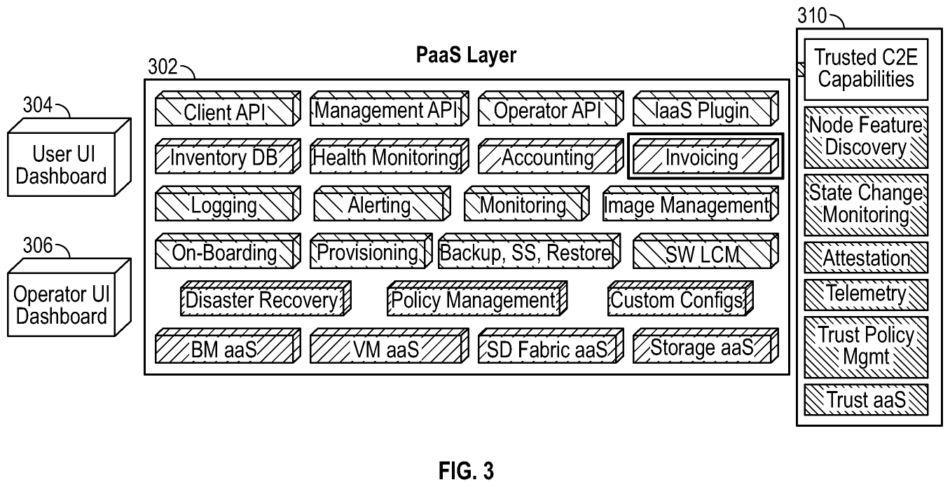

FIG. 3 is a block diagram illustrating the components of a PaaS layer (e.g., corresponding to layer 104), according to an example. Here, a PaaS layer 302 includes a variety of APIs, functions, and services to host and operate the platform. The PaaS layer 302 is operably coupled with a user (e.g., services user) dashboard UI 304 and an operator (e.g., administrator) dashboard UI 306 to invoke use of these APIs, functions, and services. The features discussed herein introduce the use of trusted C2E capabilities 310 for the PaaS layer, which include but are not limited to: node feature discovery; state change monitoring; attestation; telemetry; trust policy management; and trust services (e.g., in a “trust-as-a-service” or “TaaS” implementation).

Returning to FIG. 1, the IaaS layer 106 creates a uniform interface for allocating WL resources, e.g., compute, memory, storage, and communication that satisfy expected performance and availability requirements as specified by an SLA. The infrastructure has physical security properties such as a hardware root of trust (RoT), secure storage for keys, trusted software, and protection of secret data. Mechanisms for discovering and attesting the trustworthiness properties of the IaaS resources need to be built into the IaaS infrastructure or trust in the upper C2E framework layers cannot be guaranteed.

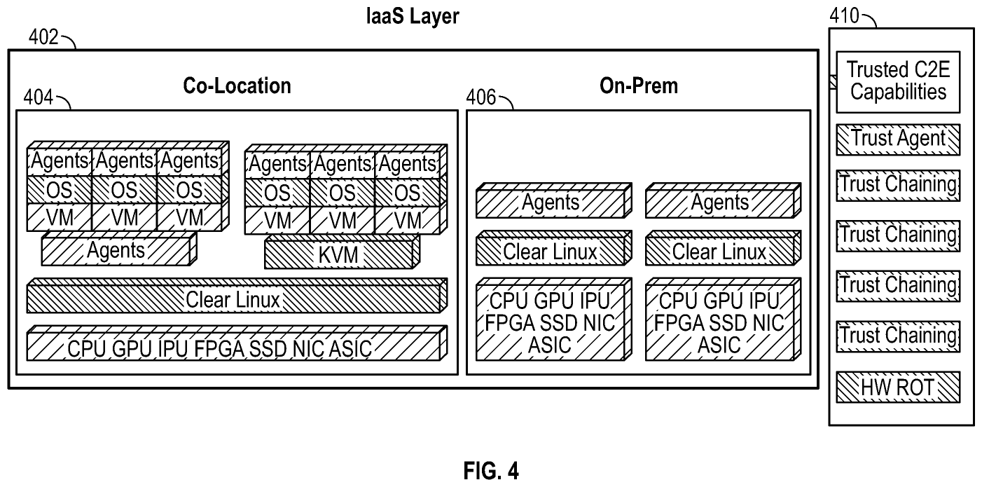

FIG. 4 is a block diagram illustrating the components of an IaaS layer (e.g., corresponding to layer 106), according to an example. The IaaS layer 402 of FIG. 4 depicts the use of co-located computing resources 404, and on-premise computing resources 406. A variety of types of computing scenarios involving virtual machines, operating systems, and hardware is also depicted. The features discussed herein introduce the use of trusted C2E capabilities 410 for the IaaS layer, which include but are not limited to: a trust agent; trust chaining (including multiple instances of such trust chaining); and a hardware root of trust.

The systems and methods described herein provide CaaS, PaaS, and IaaS layers with trusted computing capabilities that ensures the security and trust properties of the workload are represented and enforced at appropriate CaaS, PaaS, and IaaS layers. With use of the aforementioned trusted C2E capabilities, security and trust can be provided even if every infrastructure layer has an X-aaS abstraction.

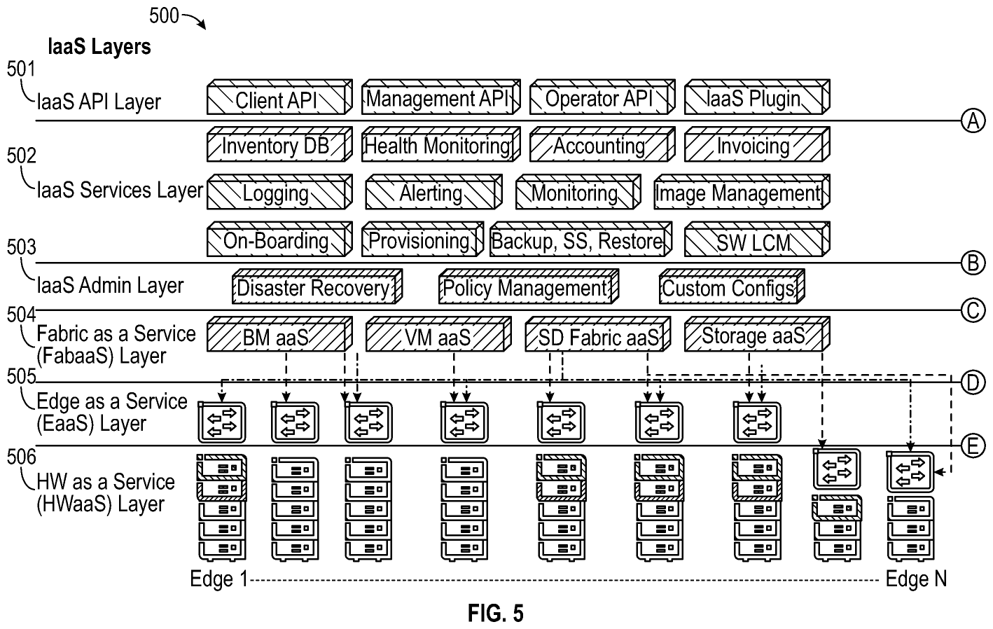

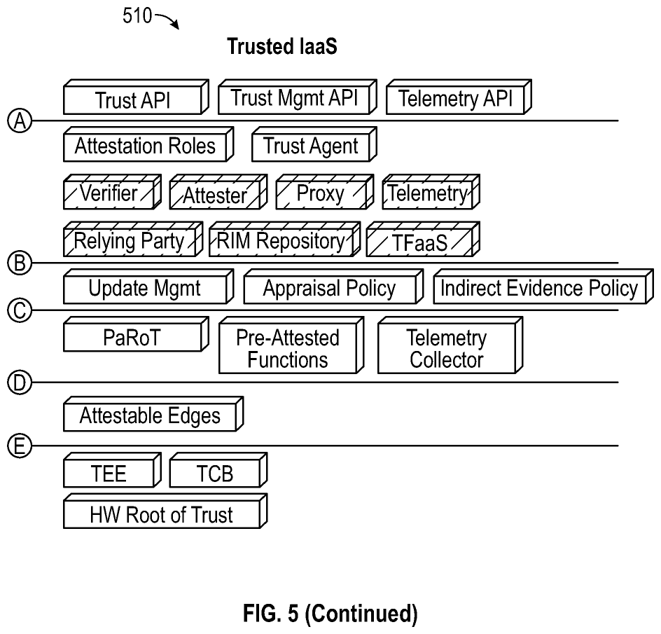

FIG. 5 is a block diagram illustrating additional aspects of IaaS layers and trust management capabilities, according to an example. The IaaS layers 500 depicted in FIG. 5 may include aspects such as: an API layer 501; a services layer 502; an admin layer 503; a Fabric-as-a-Service layer 504; an Edge-as-a-Service layer 505; and a Hardware-as-a-Service layer 506.

The IaaS layers 500 are adapted to provide trusted computing capabilities, using features of a trusted IaaS environment 510 that are supplied by trusted hardware. The relevant trusted computing capabilities include but are not limited to: HW roots of trust, trusted execution environments, edge attestation, attestation evidence collector/lead attester (e.g., “PA ROT” (Platform Active Root of Trust)), pre-attested functions, trusted telemetry collection, update management, appraisal policies, evidence policies, attestation ecosystem roles, and interfaces for the underlying trust, management, and telemetry capabilities.

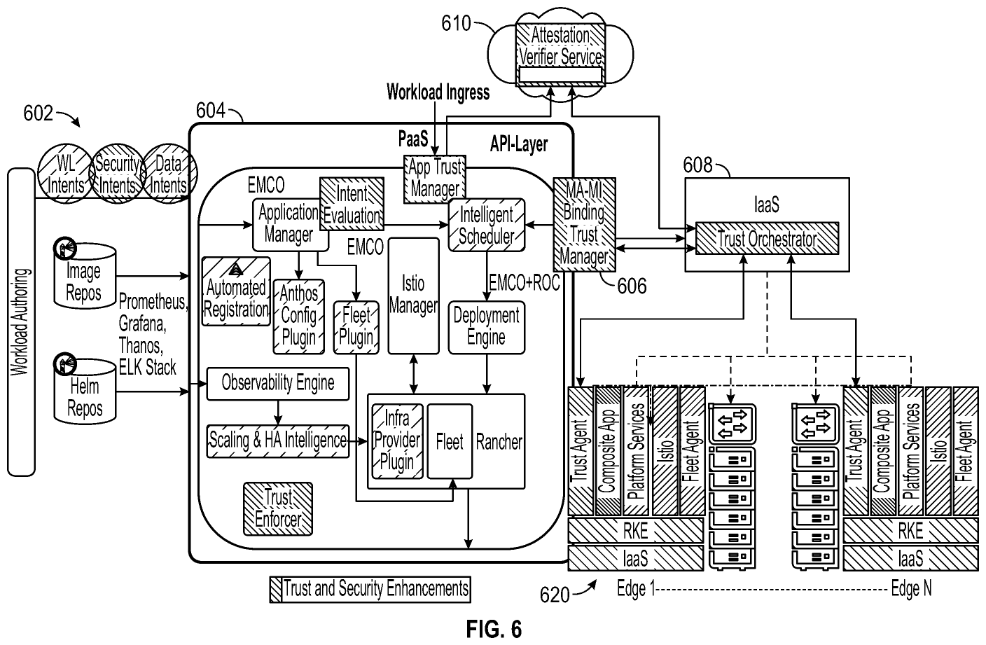

FIG. 6 is a block diagram illustrating a workflow of a workload, according to an example. The C2E framework provides trust capabilities that are also integrated in a PaaS layer 604, with the use of a trust binding manager 606. The trust binding manager 606 links trusted resources with trusted containers such that the binding between a container, platform, and resource is verifiable by another entity such as an attestation verifier service 610. This enables an IaaS layer 608 to successfully distribute the workloads to resources at one or more edge computing locations 620.

Trust in the container begins as part of workload authoring where the WL author supplies security intents and other intents metadata 602 that describes the parameters of trust such as expected attestation values and results. Workload authoring may also include elastic WL properties that aid in decomposing a monolithic WL into distributable parts using metadata in the form of WL intents, security intents, and data intents. This metadata may describe expected or allowed WL, module, and data composition/decomposition points as well as data ingress/egress behavior for WL nodes that optimize for remote data hosting with data flow ingress/egress. Additionally, data sensitivities are described by metadata that include policies that describe safe HW and SW environments where sensitive data may be safely and confidentially manipulated such as Intel® SGX/TDX, ARM® TrustZone, AMD® SEV, etc.

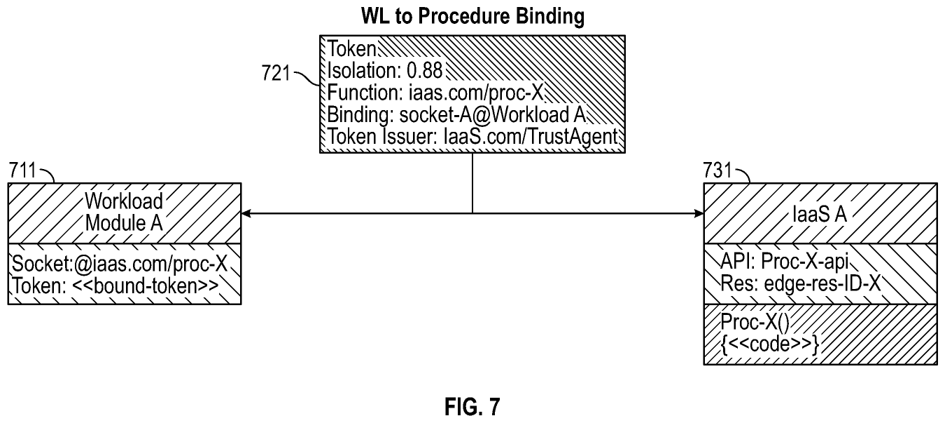

FIG. 7 is a block diagram illustrating a method of binding a workload to a procedure, according to an example. The workload binding capability is performed by the trust binding manager 606 (e.g., depicted in FIG. 6) and may be facilitated by the security intents metadata 602. The example in FIG. 7 shows a security intents token 721 that describes expected trust properties that should exist between a workload container 711, e.g., ‘Module A’ and infrastructure resources supplied by IaaS ‘A’ 731. The example describes a container socket that may be satisfied by a resource exposing a resource interface that supplies the resource, (e.g., edge-res-ID-X) and procedure (e.g., ‘Proc-X( )’) that exists inside a trusted execution environment (e.g., Intel® TDX trust domain or IPU).

The trust binding manager 606 ensures that the binding occurs following an expected binding procedure, e.g., website-for-the-iaas-platform.com/proc-X, using an expected container socket, e.g., ‘socket-A@Workload-A’, with an expected isolation factor, e.g., ‘0.88’. The binding operation may produce a token that is given to WL A and presented to an IaaS resource hosting a processing unit (e.g., a networked infrastructure processing unit or “IPU”) where it is evaluated upon resource access to verify that the binding operation has taken place. The token may expire to ensure the binding operation is periodically reestablished or the token is dynamically regenerated if either the resource environment or the container environment changes in a way that affects trust.

### Agile Pod Creation Following Automated Updates

Elastic WL updates are more sophisticated than traditional cloud or edge WL updates because elastic WLs may be partitioned and distributed dynamically after the orchestrator commissions the WL for execution. Elastic WLs possess metadata that describes the various ways that a WL may be partitioned and distributed such that the global execution objective remains the same after elastic partitioning and distributed hosting. Nevertheless, elastic WLs are subject to updates and patches that correct bugs, close security holes, or provide efficiency, reliability, resiliency, and availability improvements. Updates will comprehend the dynamically applied partitioning and distribution functions that have been applied or updates will likely fail. Otherwise, the partitioning and distribution optimizations may need to be backed out, and then the update can be applied before reapplying the partitioning and distribution operations, which incurs significant deployment cost.

The systems and methods described herein address gaps in workload software and firmware updates, particularly through the application of attestation and stronger platform integrity management. The broader industry is demanding these capabilities (e.g., attested workloads) as part of a “Zero-Trust Architecture”, see SP 800-207, Zero Trust Architecture, published by the NIST Computer Security Resource Center (CSRC) which defines a set of requirements and principles for trustworthy enterprise, edge and cloud deployments. In particular, the systems and methods described herein solve the problem of uncoordinated and disruptive updates for elastic WLs by leveraging elastic WL metadata that describes the ways in which a WL may be partitioned and distributed. The metadata is used to design WL update images that align with current deployments. The most appropriate update image is delivered to the currently deployed WL fragment for application/installation. The approaches include elastic WL metadata that is used to construct, distribute, and apply WL updates. The approaches include use of an elastic WL Distribution Manager (WDM), Workload Update Manager (WUM), Pod Update Manager (PUM), and other infrastructure.

If a WL—or pod of containers that implements the WL—is part of an elastic deployment (e.g., replica set), the systems and methods described herein use an API to temporarily disable the workload deployment following the approach: “do not try to adjust number of active copies.” If the instance on the machine that needs an upgrade is paused, the deployment operator would require new resources to recreate the pod elsewhere. After the WL/Pod is upgraded, the WL/Pod in that machine is restarted. This approach saves time, overhead and cost, whereas downloading the pod image elsewhere, allocating resources, setting up IP connectivity, etc. is significant. A respective infrastructure node has a local PUM, and this local PUM interacts with a WUM that coordinates application of updates across the cluster of elastic WL containers and nodes.

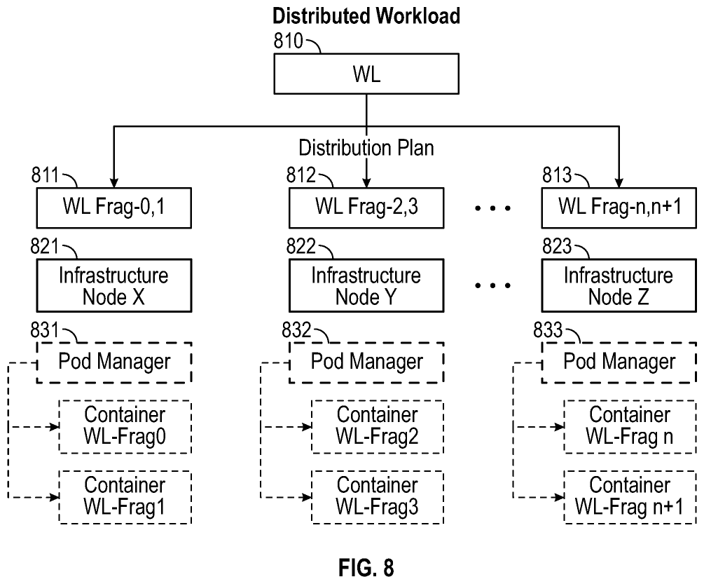

FIG. 8 is a block diagram illustrating an elastic WL distribution plan involving a WDM interacting with Pod Managers 831, 832, 833, according to an example. A WL distribution plan may describe the ways in which an elastic workload may be divided into WL fragments 811, 812, 813 such that the overall execution of the monolithic WL 810 is isomorphic to the fragmented WL. The WL fragments 811, 812, 813 may be distributed across edge network resources, such as Infrastructure Nodes X, Y, Z 821, 822, 823. An edge hosting infrastructure may be used to host one or more of the WL fragments 811, 812, 813.

A respective K8S Pod Manager may be used to manage and track multiple WL fragments hosted by a common IaaS partition. For example, an IaaS Node X 821 may host fragments (0, 1) of a WL while Node Y 822 hosts fragments (2, 3) and Node Z 823 hosts fragments (n, n+1) and so forth.

It is understood that the Elastic Infrastructure Node (EIN) may support multi-tenancy where different tenants operate their own pod of containers. Examples described herein also depict a single-tenant scenario.

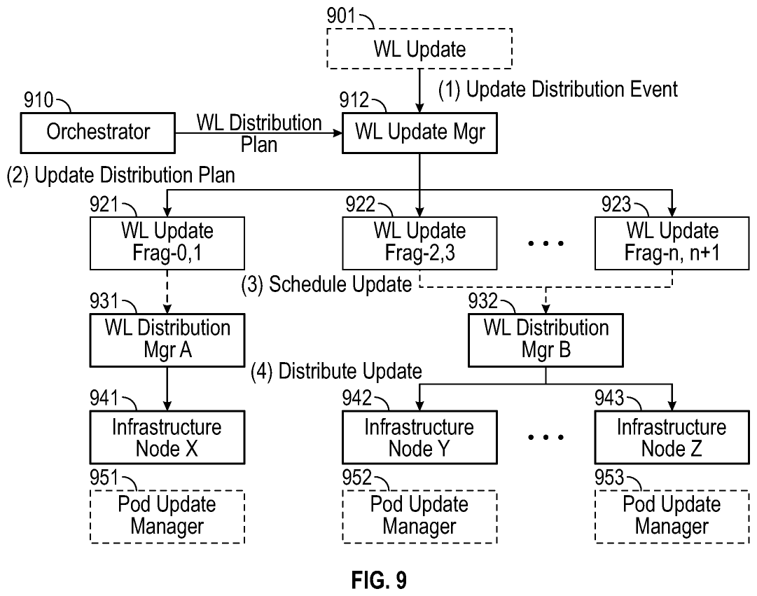

FIG. 9 is a block diagram illustrating an elastic workload update manager, according to an example. The elastic WUM depicted in FIG. 9 includes a WUM 912 that receives a WL distribution plan from a WL orchestrator 910 and a WL update distribution event 901 (Operation 1), which is used to identify the distributed elastic WL nodes to target for update with the fragments 921, 922, 923. An update distribution plan is created and distributed (Operation 2) to affected WL Distribution Managers (WDM 931, 932) that schedule affected nodes for update (Operation 3). The WDMs distribute and otherwise apply the update to affected infrastructure nodes (Node X 941, Node Y 942, . . . , Node Z 943) (Operation 4), where a local pod update manager (PUM 951, PUM 952, PUM 953) completes the update.

Distributed workloads in an elastic WL are images that are in various stages of a deployment lifecycle involving creation, distribution, resource binding, execution, update, coalescence, and retirement. Elastic WLs have elasticity parameters that are described by metadata (e.g., where WL node replicas can exist and where several nodes serve as redundant nodes that may perform parallel execution of a node). Additionally, pipelined execution can exist where the input of one node in an elastic WL cluster is satisfied by the output of another cluster node forming a chain of operations that execute in sequence. Elastic WL data objects may be assigned to one or more WL nodes for shared or exclusive access. A hierarchical lock structure may be used to guarantee sequential and parallel executions can occur simultaneously while still maintaining overall integrity of the elastic workload.

A WL node may have multiple execution states, (e.g., ready to run, running, blocked on hosting resource, blocked on input, blocked on output, blocked on partitioning, frozen, zombie, etc.). The WL node's image therefore can be copied, replicated, stored, encrypted, etc. to comply with node lifecycle, security, resiliency, and durability requirements.

An elastic WL has various lifecycle and execution states that can be represented as one or more fille images. A “pod” filesystem therefore can be used that allows WL images to be manipulated by a distributed files system interface (e.g., IPFS, GFS, HDFS, Cefph) where a distributed filesystem hierarchy contains WL images are serialized Pods, Containers, Workloads, Distributed Workloads, etc. that map to objects in an Elastic Workload Filesystem (EWFS). As used herein, an EWFS refers to any cloud- or edge-distributed filesystem containing serialized WL images. The EWFS configuration may be described by metadata such as SWID or CoSWID that models a filesystem abstraction, where a distributed filesystem is also described by a filesystem abstraction. Here, different nodes in an elastic cluster can a namespace in a filesystem hierarchy and the various elastic workload lifecycle states may be represented as files or sub-directories of the EWFS filesystem namespace. The EWFS metadata may be used to specify an expected deployment configuration, deployment status context, deployment lifecycle archive, and elastic workload data distribution model.

The elastic WL configuration enables performance improvements while being cyber-resilient. Elastic WL telemetry and AI/ML algorithms may add greater context for leveraging WL archives that quantify WL lifecycle overhead (e.g., pause/restart vs. decommission/recommission). For example, the elastic WL equivalent of a suspend-resume state “S3” in an operating system process suspend/resume may record resource utilization, latency, network bandwidth and so forth. Thus, the overhead that is associated with WL lifecycle transitions can be analyzed, when these measurements are available for analysis and optimization of WL microservices.

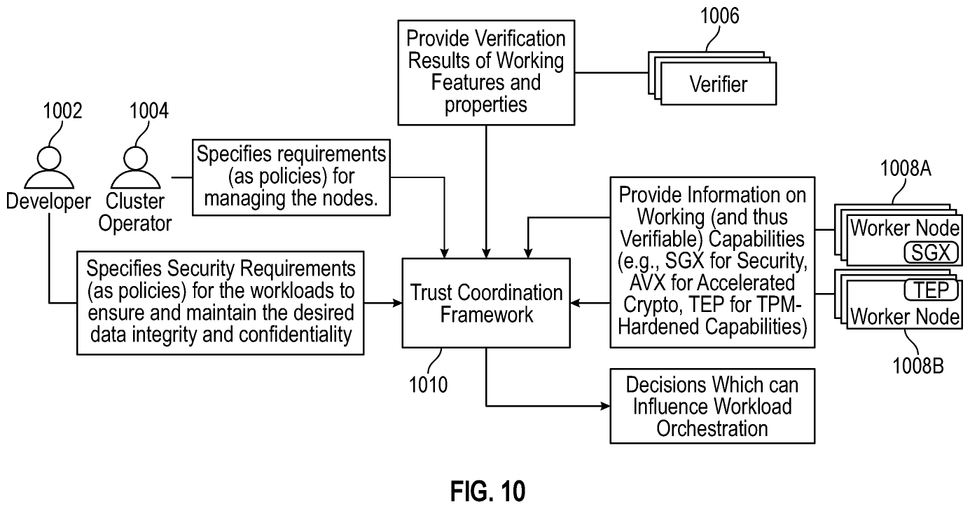

FIG. 10 is a diagram illustrating trust coordination, according to an example. As observed by reviewing FIG. 10, there are many problems and challenges in solving trust coordination. A developer 1002 may specify security requirements (in policies) for workloads, whereas a cluster operator 1004 may specify requirements (in policies) for managing nodes that operate the workload. Multiple policies contribute metadata relating to security (e.g., relating to the policies, requirements, working capabilities, and software properties). However, this metadata is often heterogeneous (e.g., is not bound to a particular software or hardware technology). Additionally, a verifier 1006 may be invoked to obtain verification results of working features and properties. Additionally, a worker node 1008A or 1008B may use different technologies and provide information on working (and thus verifiable) capabilities.

Systems and methods described herein provide for trust coordination across heterogenous elements in an C2E setting, with use of a trust coordination framework 1010. This framework 1010 provides a mechanism for processing of heterogeneous multi-party metadata that includes collection, analysis (reasoning) and dynamic reassessment of policies over metadata. The framework 1010 simplifies evaluation of relevant metadata and policy management, and makes or assists decisions that influence workload orchestration. The framework 1010 relieves reliant services (e.g., dependent services) from the complexity of handling metadata and policies (in terms of quantity, size, and heterogeneity), such as by SGX attestations, TPM attestations (like in Keylime), software supply chain assertions, data provenance assertions, etc. The framework 1010 also consolidates metadata and policy handling in a single instance for multiple relying services. The framework 1010 also minimizes code maintenance of relying services to update metadata formats and policies.

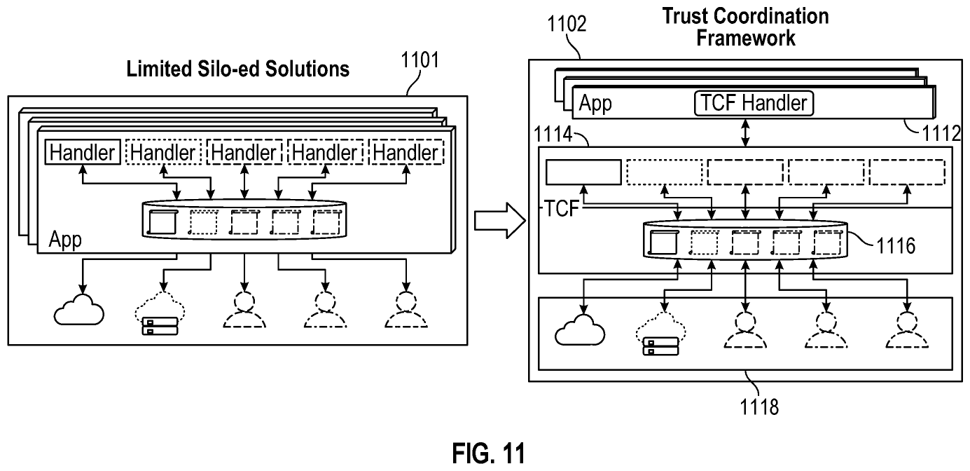

FIG. 11 illustrates siloed approaches as contrasted with an advancement to a trust coordination framework (TCF), according to an example. Current deployments 1101 use metadata collection and analysis on a per-app (per-microservice) basis, and are typically not scalable while being difficult to build and maintain. In contrast, a TCF 1102 acts as an active intermediary to establish trustworthiness based on verifiable information across compute nodes, workloads, and data. The TCF 1102 separates metadata collection, handling, and policy management from apps/microservices 1112. The TCF 1102 provides a single framework for multiple deployment scenarios 1114. The TCF 1102 allows reuse of metadata, handlers, and policies 1116 and enables policy decisions over heterogeneous metadata/technologies and users 1118.

The TCF 1102 simplifies metadata and policy management by relieving “relying” services (e.g., dependent services) from the complexity of handling metadata and policies—in terms of quantity, size, and heterogeneity. For instance, the relying services may include Intel® SGX, Intel® TDX, DICE or TPM attestations (or attestations from a similar secure environment), software supply chain assertions, data provenance assertions, etc. Use of the TCF 1102 also consolidates metadata and policy handling in a single instance for multiple relying services and avoids code maintenance of relying services to update metadata formats and policies.

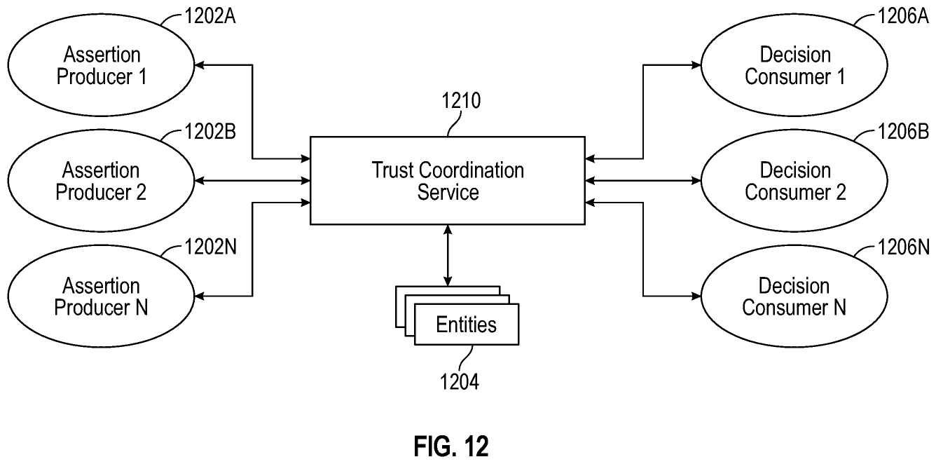

FIG. 12 is a diagram illustrating interoperability of a trust coordination service, according to an example. Trust coordination in this scenario includes the following Actors: assertion producers 1202A, 1202B, . . . 1202N, which produces assertion related to the entity capabilities, platform properties, and/or verification results (e.g., related to hardware-based attestations, SW properties, etc.); decision consumers 1206A, 1206B, . . . 1206N, which consumes a policy trustworthiness decision per requested entity; Entities 1204, which are the subject for trustworthiness that present attributes of trustworthiness; and a trust coordination service 1210, which aggregates the metadata and makes decisions based on provided policies.

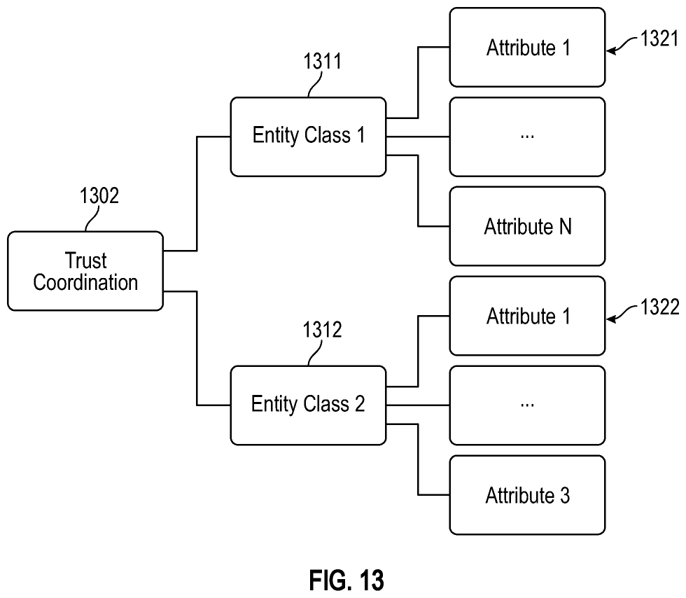

FIG. 13 is a block diagram illustrating a general hierarchy of classes and attributes, according to an example. A respective component of the compute continuum can associate trust coordination 1302 with several entity classes (e.g., 1311, 1312). A respective entity class may have associated trustworthiness attributes (e.g., 1321, 1322), such as attestation, provenance, a Software Bill of Material (SBOM) assertion, safety, resiliency, etc.

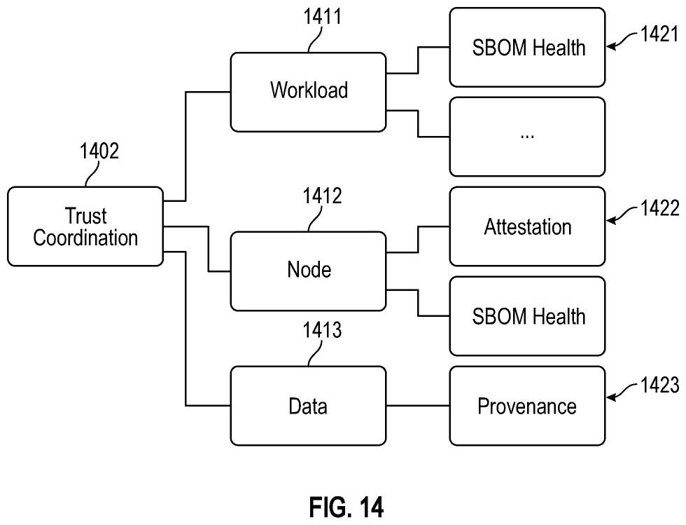

FIG. 14 is a block diagram illustrating a specific hierarchy of classes and attributes, according to an example. Here, there are three classes that are illustrated for trust coordination 1402: workload 1411, associated with attributes 1421 for native workload or containers; node 1412, associated with attributes 1422 for compute resources; and data 1413, associated with provenance attributes 1423 for structured or unstructured data that is generated or consumed.

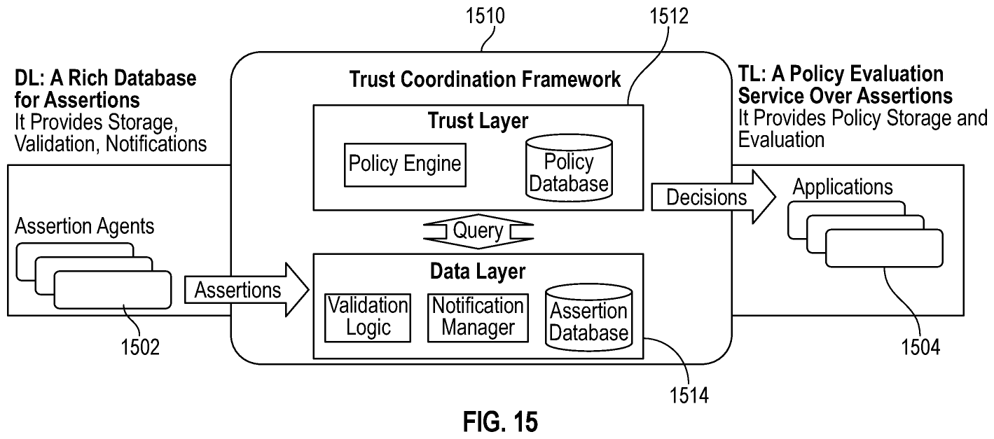

FIG. 15 is a block diagram illustrating a trust coordination framework architecture, according to an example. An embodiment of a trust coordination framework 1510 illustrated in FIG. 15 includes two layers. A data layer 1512 is responsible for the assertion validation, collection, storage, and notification. A trust layer 1514 contains a policy engine and provides policy storage and evaluation services. Assertion agents 1502 feed assertions to the data layer. Such assertions are signed for accountability and integrity. The trust layer finally provides policy decisions (evaluated over the assertions in the data layer) to applications 1504 (or relying parties).

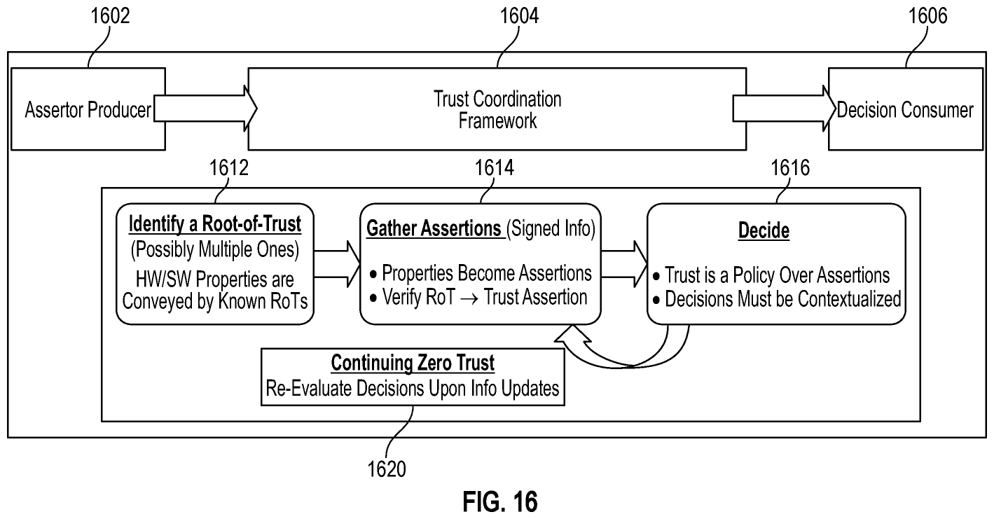

FIG. 16 is a block diagram illustrating high-level operations in a trust coordination framework architecture, according to an example. These operations are coordinated among an assertor producer 1602, providing information to a trust coordination framework 1604 for evaluation, which then provides decision information to a decision consumer 1606.

The high-level operations are used to assess the trustworthiness of platforms, software, or workloads. First, the necessary Root-of-Trusts (RoTs) are defined at operation 1612. The RoTs will convey (or will certify other parties who will convey) software and/or hardware features and properties. Second, assertions are collected at operation 1614. Finally, a policy is evaluated at operation 1616 to determine a decision. As the context changes (e.g., new assertions are collected, or previous assertions are updated), policies are (or can be) re-evaluated at operation 1620 to confirm previous decisions, or to trigger contingency actions. In further examples, open-source solutions such as Open Policy Agent (OPA) or another policy engine can be used for policy specification and evaluation.

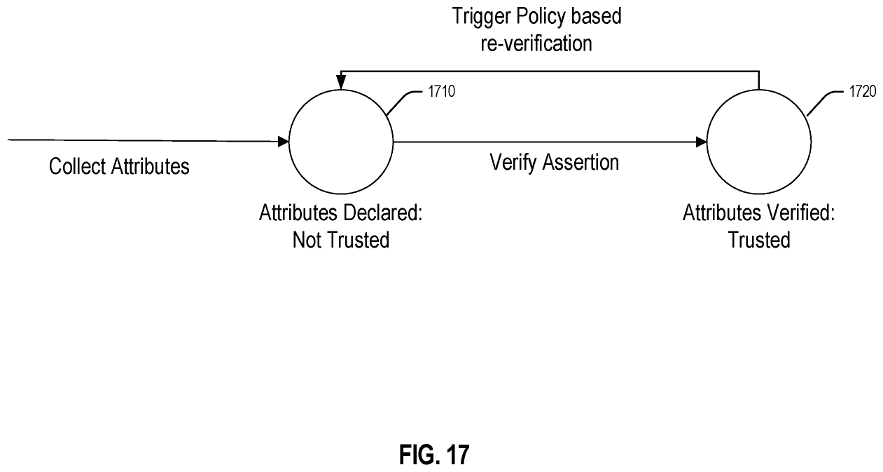

FIG. 17 is a block diagram illustrating state transitions of trustworthiness attributes, according to an example. Attributes transition from a non-trusted state 1710 to a trusted state 1720, based on verifying a declared attribute assertion. Subsequent re-verification may be used which triggers a policy. (In practice, the attributes may be continually in a trusted state, but the relying party that is modeling attribute trust may maintain a distinct or separate attribute state machine that models the attribute state transition as a way to achieve trust consistency over a distributed set of nodes).

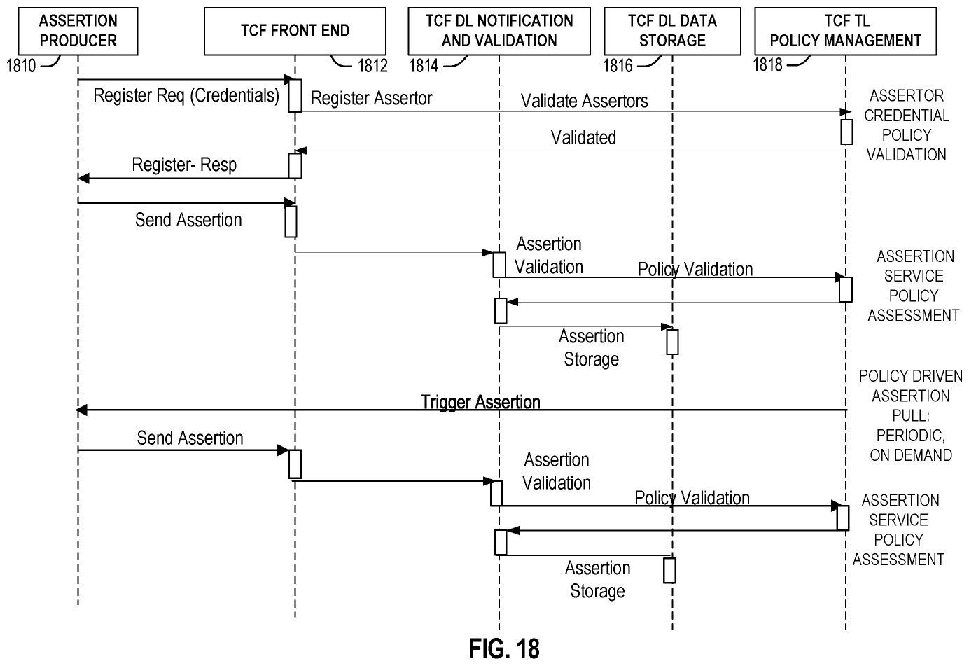

FIGS. 18-20 are swim lane diagrams illustrating interactions between respective components of a trust coordination framework architecture, according to various examples.

In FIG. 18, an assertion producer 1810 provides a request to a trust coordination framework front end 1812. The trust coordination framework data layer (DL) provides notification and validation functions 1814 and data storage functions 2816, whereas the trust coordination framework trust layer (TL) provides policy management functions 1818.

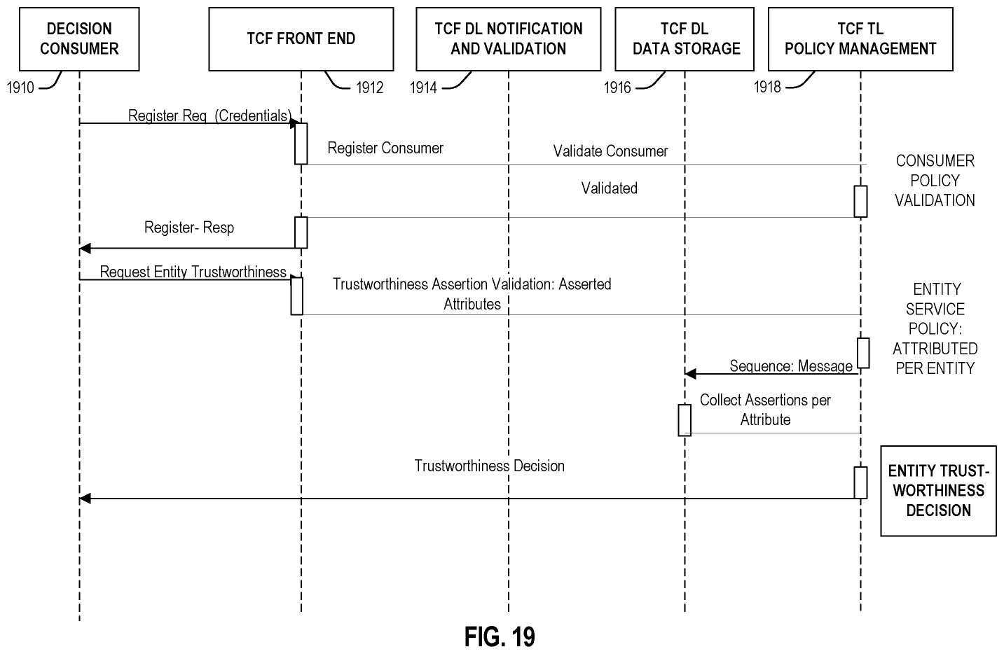

In FIG. 19, a decision consumer 1910 provides a request to a trust coordination framework front end 1912. The trust coordination framework data layer (DL) provides notification and validation functions 1914 and data storage functions 1916, whereas the trust coordination framework trust layer (TL) provides policy management functions 1918.

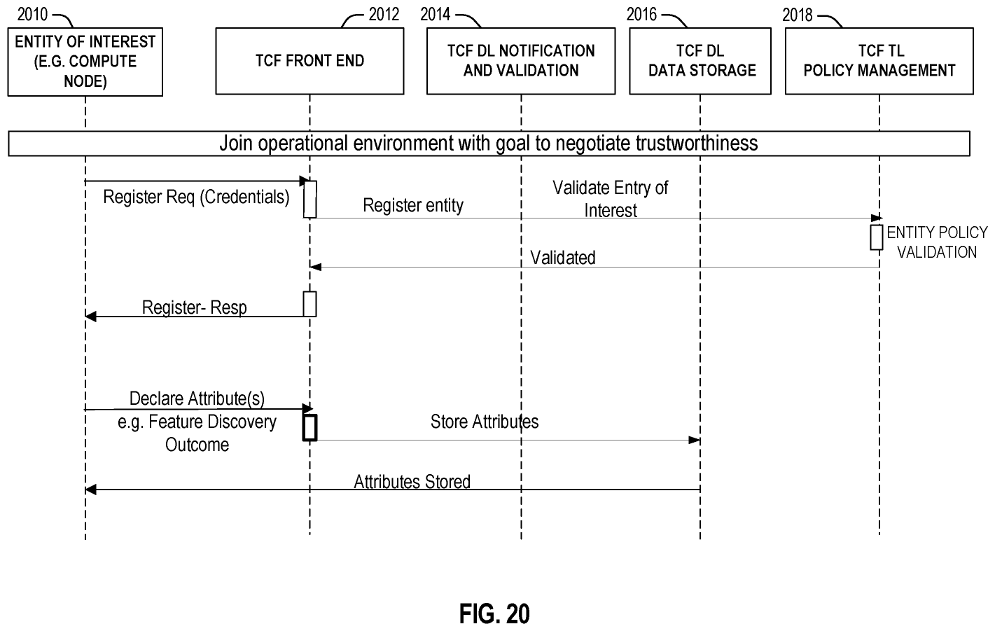

In FIG. 20, an entity of interest 2010 (such as a compute node) communicates with a trust coordination framework front end 2012 to join the operational environment. The trust coordination framework data layer (DL) provides notification and validation functions 2014 and data storage functions 2016, whereas the trust coordination framework trust layer (TL) provides policy management functions 2018.

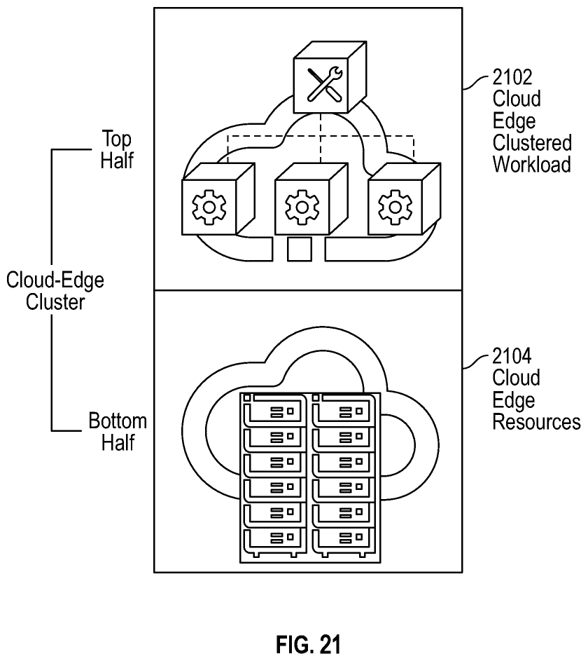

FIG. 21 is a block diagram illustrating a cloud-edge cluster, according to an example. The cloud-edge cluster shows a typical C2E deployment having a top half 2102 with one or more C2E Workloads and a bottom half 2104 with one or more resources (e.g., CPU, storage, memory, sensing, etc.) that are bound to the top-half workload. A workload can be monolithic or divided into distributed workload parts (e.g., with respective parts performing a portion of the monolithic workload). The workload data may be merged or integrated with the workload execution or may be accessed remotely upon demand or may be cached to minimize network latency overhead. Cached data may be updated as needed and write-through caching may be used to ensure data consistency.

The top half 2102 is bound to bottom half 2104 resources as part of a C2E Cluster deployment. Initial deployment may allocate a set of top half nodes that are scheduled to run using bottom half resource nodes. Binding activity may involve attestation of the resources by the top half 2102 prior to binding to a bottom half 2104 or attestation (e.g., WL/data provenance evaluation) of the top-half workload and data by a bottom-half node prior to binding. Binding may be facilitated by orchestration or resource manager nodes.

After binding, the resultant cloud-edge node may begin processing the workload. Distributed workloads may produce output that is consumed by a peer cloud-edge node originating from the same monolithic workload. Peer cloud-edge nodes that act as consumers or producers of other peers may attest the peer prior to consuming WL inputs from a peer or prior to sending WL outputs to a peer. Mutual attestation ensures the peers are indeed peers and that they are bound to resources that satisfy an overarching and consistently secure workload policy.

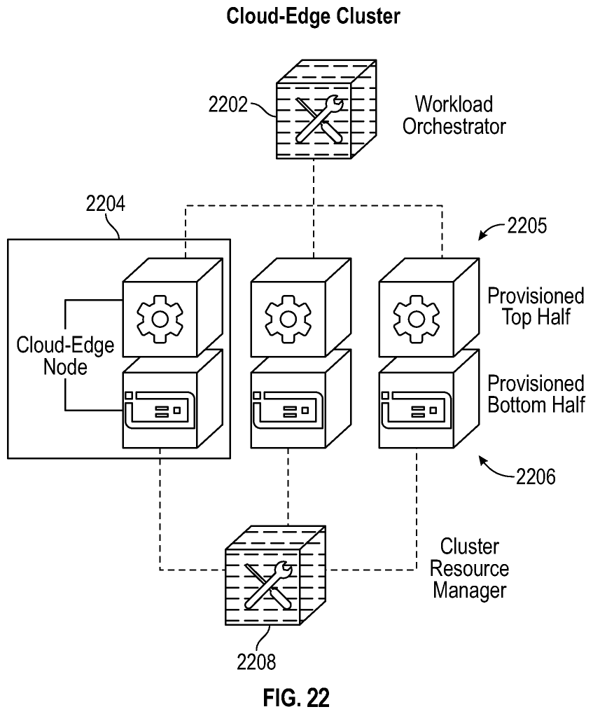

FIG. 22 is a block diagram illustrating a cloud-edge cluster after provisioning a distributed workload, according to an example. After provisioning all peer nodes in a distributed workload, the operational cluster is depicted in FIG. 22 and includes one or more cloud-edge nodes (e.g., node 2204) where a top-half workload 2205 (or partitioned workload) is bound to a bottom-half resource 2206 (or set of resources). The top-half workload 2205 may be orchestrated by an orchestration agent 2202 (e.g., Helm, Rancher) that may interface with a top-half workload 2205 (e.g., K8S pod manager). Additionally, the provisioned bottom-half resource 2206 may have a cluster resource manager 2208 that oversees operation resource utilization and optimization. The cluster resource manager 2208 may assign/de-assign resources (e.g., CPU, memory, storage, XPU, etc.) as needed to meet workload QoS requirements and to optimize power or performance.

### Isolated Execution of Elastic Workloads

Elastic workloads (WLs) dynamically partition a WL into a distributed WL that may expand or contract to accommodate resource constraints in a Cloud-to-Edge infrastructure. Elastic WLs can be hosted using Container-as-a-Service (CaaS) infrastructures (e.g., K8S), but traditional CaaS environments lack the ability to scale security, trust, and resiliency mechanisms in edge computing environments.

Distribution of a WL requires allocation of multiple hosting environments that may have dissimilar security, trust, and resiliency properties. An SLA may specify service level performance, quality, security, trust, and resiliency requirements, but these properties are normally common to a single hosting node. An orchestrator can verify these properties statically at the time the SLA contract is accepted. However, in an elastic WL context, the dynamics of WL distribution can result in loss of security, trust, and resiliency if distributed sub-WLs have dissimilar hosting environments or during WL execution where dynamic update (e.g., patching) is permitted.

Further, trusted execution environments (TEEs) (e.g., Intel® SGX Enclave, Intel® TDX Domains, ARM® TrustZone, AMD® SEV, etc.), may provide tenant-specific protection of isolated execution (ISOX) resources, but there are limited ISOX resource available for scaling FaaS hosting on a platform. This resource scarcity is compounded in dynamic elastic WL distributions. To provide proper isolation, WLs may be encrypted prior to loading an ISOX and an ISOX may be provisioned with a security context that enables WL code and data decryption. FaaS optimized singleton function execution and scalability are achieved through hosting multiple tenants that execute the same function while maintaining tenant isolation properties. However, tenant isolation may restrict performance or waste memory and storage resources when tenants use the same data, such as attestation reference values, or the same trust preserving functions.

Thus, there is a need for better security, trust, and resiliency management in dynamic elastic workloads that provides resource efficiencies for tenant-isolated workloads.

The systems and methods described herein provide fast provisioning and paging of isolated execution environments to increase resource efficiency. Tenant security contexts are mapped to ISOX resources and ISOX resources are able to be reused by changing a security pointer from one tenant to a different tenant for the ISOX resource. This reduces the number of ISOX resources that are needed, the overhead for startup and teardown of ISOX resources, and communication overhead when using many ISOX resources.

As discussed, tenant-isolated elastic WLs may inefficiently use server resources because much of the elastic WL container contains common data and functions, which are cached in isolated cache lines, resulting in less efficient use of execution resources. To address this, an Isolated execution Manager (IXM) is used to observe security contexts and metadata of WL containers that are scheduled to run on a particular infrastructure node. The IXM observes when there is overlapping security contexts for ISOX functions in a run queue. Overlapping data may be cached in a read-only shared memory frame to improve cache resource efficiency while maintaining tenant isolation requirements. Additionally, FaaS functions may be pre-attested and loaded into an instruction/function cache. The instruction/function cache may remain warm across multiple tenant-isolated WLs that use the same FaaS function. These operations improve the function of the computers by consolidating and sharing common data and functions, because tenant-isolated workloads normally require all tenant-specific data (including data that is not a tenant secret) to be separated from another tenant. The computer's (e.g., FaaS server) operation is improved with lower latency, less storage and memory usage, and less network utilization. Further details are provided in the examples and figures described below.

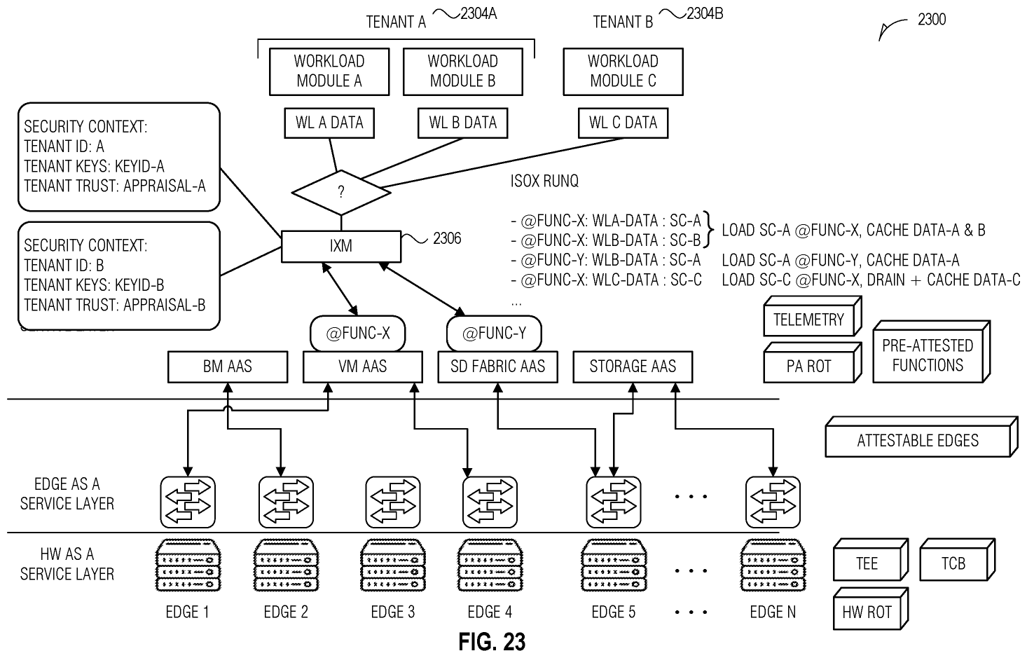

FIG. 23 is a diagram illustrating an operating environment 2300, according to an example. A function-as-a-service (FaaS) server provides elastic WLs on behalf of multiple tenants (2304A and 2304B) in an edge network. Tenants 2304A-B require isolated execution environments, which includes isolating functions and data from peer tenants 2304A-B.

An Isolated execution Manager (IXM) 2306 monitors security contexts of the tenants 2304A-B. The IXM 2306 may be implemented as part of a hypervisor, virtual machine manager (VMM), or as a separate application. In general, the IXM 2306 supports a trusted execution environment (TEE) (e.g., Intel® SGX Enclave, Intel® TDX Domains, Intel® TDX Secure Arbitration Mode (SEAM), ARM® TrustZone, AMD® SEV, AMD® Trusty, etc.). The IXM 2306 supports an isolated execution environment for each tenant 2304A-B and their respective WLs. The IXM 2306 is able to identify commonality across WLs and WL data. The IXM 2306 may not be privy to secrets (e.g., keys) that are in the security contexts. If there is commonality between WLs or WL data, then the common WL data is shared between tenants 2304A-B in a read-only cache. The read-only cache may be configured without security constraints (e.g., encryption) or with fewer security constraints compared to the isolated execution environments of the tenants 2304A-B.

Similarly, if the tenants 2304A-B share FaaS functions, the attestation results of pre-attested functions may be warmed in a function cache that is shared between tenants 2304A-B. Trusted FaaS functions typically use attestation before they are assigned to a tenant-specific WL. However, if the function is pre-attested and cached, then the next tenant 2304A-B that uses the same function will not need to perform the attestation operation. The pre-attested FaaS functions do not contain tenant-specific data or secrets. When a pre-attested FaaS function relies on tenant-specific data or secrets, the function may be provided input parameters including pointers to the tenant-specific cache lines that contain the tenant-specific data or secrets.

In some implementations, Trusted Execution Environments (TEEs) may be used for tenant isolation. Normally, each enclave or domain is fully isolated by default. In some cases, tenants may share memory with approval from the other tenants. However, this is unneeded overhead when the data or functions are common to the tenants and do not include secret information. This situation can be found in elastic WLs. Elastic WLs have built-in security, trust, and resiliency capabilities that can be common across the WL hosting infrastructure. These common capabilities may be described by metadata schema that can be interpreted by the IXM 2306. The read-only WL metadata can be associated with a cache line that does not require cooperation by the tenants 2304A-B to setup the shared memory region. In this way, the common data and functions can be reused across multiple tenants 2304A-B without having to obtain permission from all of the tenants 2304A-B. The IXM 2306 provides provisioning and paging of the isolated execution environments by paging out security contexts and reusing common elements.

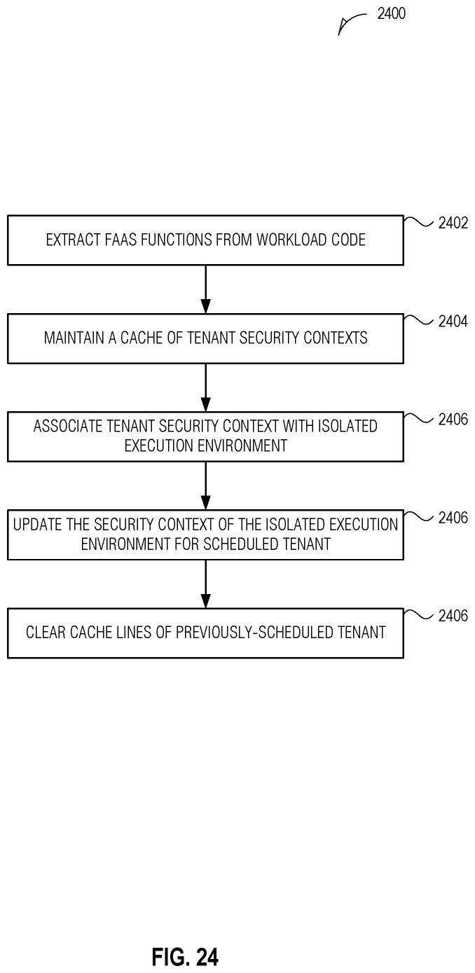

FIG. 24 is a flowchart illustrating a process 2400 for fast provisioning and paging of isolated execution environments with tenant-specific security contexts, according to an example. At 2402, FaaS functions are extracted from WL code. Workloads may contain function references (e.g., named function networking (NFNs)) where a FaaS server or container has a native, optimized implementation (e.g., pre-loaded FPGA design but for an ISOX). The WL code uses a function reference (e.g., @function-X or a NFN address) instead of including function as code. When a WL needs function-X processing, the WL gets scheduled on the ISOX that is pre-configured with tenant-X security context. The FaaS server extracts the WL code by looking for references to functions. Similarly, data references may be identified in 2402, by analyzing the code and determining references to common data. The references may use a Named Function Networking (NFN) expression or Named Data Networking (NDN) expression.

At 2404, the IXM gathers and maintains a cache of tenant security contexts that have been configured for local isolated/enclave execution. The cache allows the security context to be “paged out” to allow another tenant a “time slice” within an isolated/enclave environment. A “paged out” workload does not need to wait before getting another time slice if the workload has other functions that can execute. If the local platform supports multiple FaaS functions, and the workload can utilize the other functions, then the paged-out WL can execute other functions while waiting for another time slice to execute the first function further.

At 2406, the IXM associates the tenant security context to multiple (FaaS specific) ISOXs. The IXM does not need to maintain multiple security contexts for multiple FaaS functions for the same tenant.

At 2408, the IXM updates the ISOX's security context (pointer) to reference the next tenant scheduled to run (using FaaS function X). This provides fast paging and security context switching. Because multiple tenants may use the same function X, only the input data changes. The security principle for object reuse expects the previous tenant's security context pointer will reliably be erased and the next tenant's security context pointer instantiated. Additionally, if function-X processing involves caching tenant-specific data, then at 2410, cache lines are drained (e.g., set to zero or otherwise erased) and the initialized environment is then safe to load the next workload for execution.

### Workload Security, Trust, and Resiliency

Workloads can be hosted using Container as a Service (CaaS) infrastructures, e.g., K8S, but traditional CaaS environments lack the ability to scale security, trust, and resiliency mechanisms in edge computing environments. Distribution of a WL requires use of multiple hosting environments that may have dissimilar security, trust, and resiliency properties. An SLA may specify service level performance, quality, security, trust, and resiliency requirements, but these properties are normally common to a single hosting node. An orchestrator can verify these properties statically at the time the SLA contract is accepted. However, in an elastic WL context, the dynamics of WL distribution can result in loss of security, trust, and resiliency while a WL executes. What is needed is a mechanism to maintain security, trust, and resiliency requirements at the CaaS level.

The systems and methods described here employ security, trust, and resiliency (STR) managers. The STR managers may be used to interact with CaaS framework services. CaaS framework services may include Security as a Service (SaaS), Trust as a Service (TaaS), and Resiliency as a Service (RaaS) services that may update security, trust, and resiliency requirements dynamically.

The STR managers employ node observer functions that detect operational conditions that violate or negate expected security, trust, and resiliency requirements (e.g., those expressed in an SLA). The observers are embedded into CaaS containers and into IaaS or ISOX resources ensuring they are always available to the CaaS framework.

Security and resiliency properties often involve embedding the behavior that protects resources and optimizes for resilience regardless of the user workload. Often, the workload designer focuses on application objectives, largely ignoring security and resiliency. By embedding security and resiliency behavior in a standard workload runtime environment, the security and resiliency properties are inherited by the hosted workload. The set of runtimes converges to a smaller number making it easier to apply a common security and resiliency approach that is inherited by the WL upon binding the WL to the hosting environment.

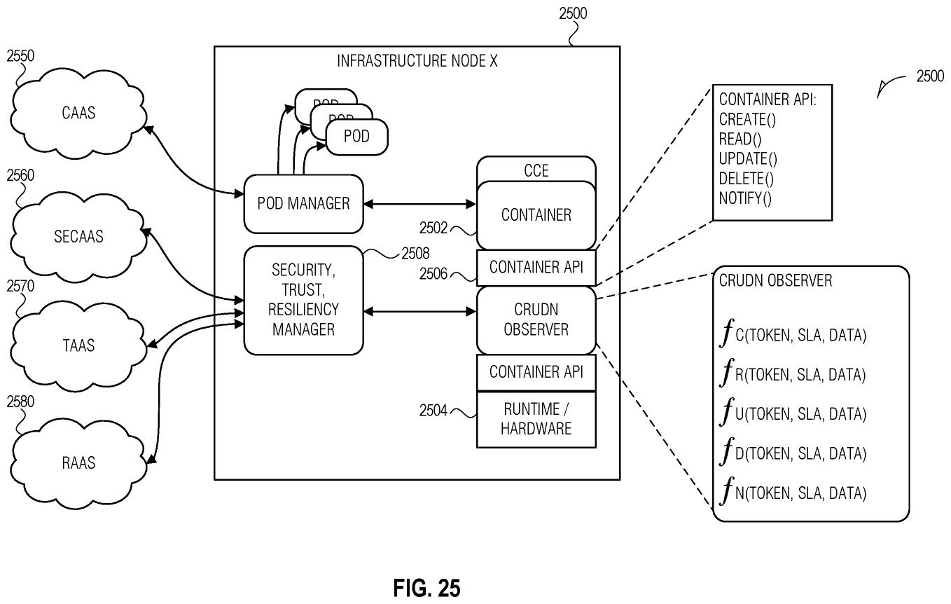

FIG. 25 is a block diagram illustrating an infrastructure node 2500, according to an example. The infrastructure node 2500 may be an edge node, a core node, or an elastic WL node, which can execute a part of a workload. A container 2502 is bound to the infrastructure node 2500. The infrastructure node 2500 is configured to provide resources 2504 to the container 2502, including memory, processing, network, storage, or other resources.

The container 2502 may be managed in a CaaS framework 2550 (e.g., Kubernetes), where the CaaS framework 2550 is used to manage a container environment. The container environment includes the container 2502 and its runtime and system interface layer accessed via system call interfaces (e.g., via a container application programming interface (API)).

A workload may perform a variety of application-specific operations but those involving system resources use a container runtime API 2506. The container API 2506 may include a set of functions that operate on a resource (e.g., read memory, update file in storage, create file, delete data, etc.). For example, a typical resource lifecycle may include Create, Read, Update, Delete, and Notify (CRUDN) events. The container runtime API 2506 may accept a variety of parameters related to security, trust, resiliency, and service level agreement requirements for managing a resource. The parameters may be passed in a token, as a part of an SLA, or as other data.

The STA manager 2508 interfaces with a CRUDN observer 2510 to trap container API calls and parse security, trust, and resiliency parameters that are included in such calls. Depending on the type of policy being enforced (e.g., security, trust, or resiliency), the API call may include one or more of a token, a service level agreement (SLA), or data for use in a security, trust, or resiliency operation.

A token for attestation (and other token forms) described herein may contain attributes for Authentication, Authorization, Audit, or Access control (in addition to Attestation). The token may be referred as an AAAA or “A4” token or “A5” token respectively. As such, the A4/A5 token may be supplied with a variety of network interfaces in Edge, Cloud, DApp deployments having minimal impact to API/interface design. The token may be passed directly over the interface or a reference to the token given where the receiver may obtain the token out-of-band. The token may be realized using token structures including W3C DID, CWT, JWT, XML-DSIG, CMS, and others.

The token may be used by a Security, Trust, and Resiliency (STR) Manager 2508 to perform access control over the CRUDN functions such that failure to satisfy any A4 or A5 requirements may result in the CRUDN function, fx( ), being prevented from completion. The Security and Trust Manager may offload security and trust operations to a Security as a Service (SecaaS) provider 2560, Trust as a Service (TaaS) provider 2570, or Resiliency as a Service (RaaS) provider 2580 to achieve geo-diversity of security and trust or to improve scalability across a network or system of nodes needing to establish secure and trusted interactions.

Additionally, tokens may define if and how data should be audited and may manage auditing resources locally or in conjunction with SecaaS providers 2560. Data protection requirements may be described by the token such that data encryption, integrity, replay and other data-centric protections may be applied.

Additionally, the token may describe a Confidential Computing Environment (CCE), (e.g., Intel® SGX, Intel® TDX, ARM® TrustZone, AMD® SEV, etc.), and requirements such that data and functions may be required to be performed from a CCE as a condition of further operation.

Service level agreement (SLA) or service level operations or objectives, may include directions regarding the level of service, quality and resiliency for the CRUDN function, fx( ), that may be interpreted by the STA manager 2508. The STA manager 2508 may respond to SLA requirements. For example, the STA manager 2508 may offload security operations to a security-as-a-service SecaaS provider 2560 to manage encryption keys, perform user/device authentications, to manage audit trail, or to authorize various elastic WL behaviors, e.g., distributing a WL, accessing WL data, reporting WL telemetry, etc. As another example, the STA Manager 2508 may offload trust operations to a TaaS provider 2570 to attest WL node attestation reports and to notify participant WL nodes with attestation results. As another example, the STA Manager 2508 may offload resiliency operations to a RaaS provider 2580 to achieve geo-diversity of resiliency, for example, replicating the function or data as a way to improve resiliency.

The STA Manager 2508 may be used to manage runtimes in a pod via the CRUDN observer 2510. Programmable runtime extensions, and programmable intercepts in those runtimes may be used to bridge the gap between what the application designer omitted and that which is needed by workload environment. The STA Manager 2508 may, for example, dynamically swap a security-resiliency oblivious application from the pods it is in and migrate it to hardened pods that are customized to provide the necessary security-resiliency characteristics. Migration can be achieved with bridging software libraries that abstract the security and resiliency functions in call-through interfaces that can pause, halt, or restart application execution while security and resiliency countermeasures are applied.

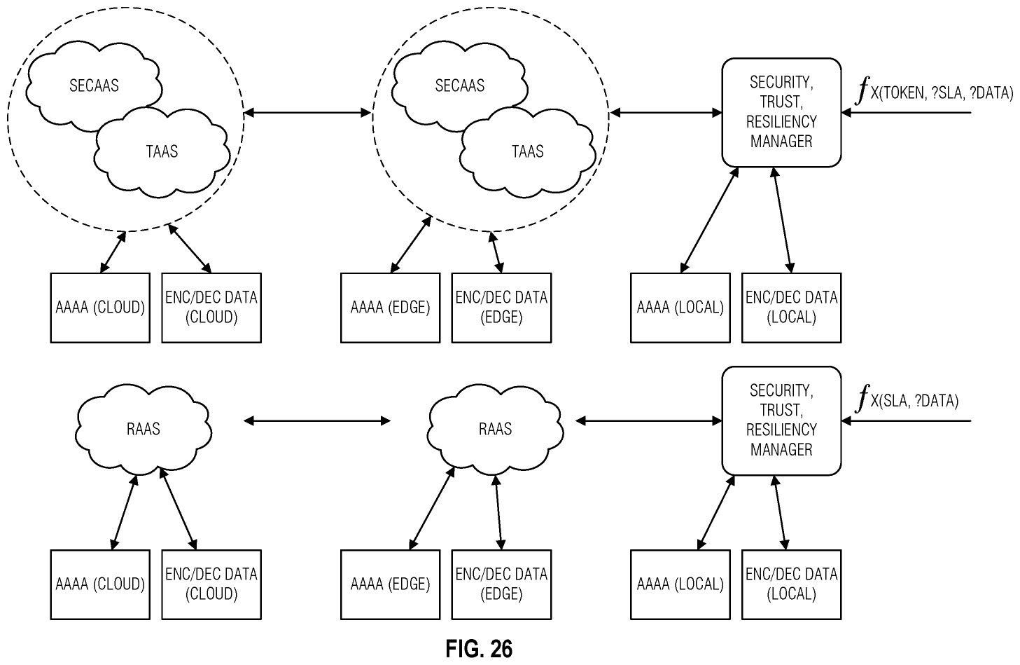

Security, trust, or resiliency may be managed at any level in the edge to cloud hierarchy. As illustrated in FIG. 26, a CRUDN function may be processed by a security or trust portion of the STA Manager 2508 to process local authentication, authorization, audit, access, or attestation operations, or the STA Manager 2508 may use a SaaS or TaaS at the edge or cloud to perform authentication, authorization, audit, access, or attestation operations on resources managed at the edge or cloud level.

After the STA Manager 2508 processes token or SLA directives included in the CRUDN function fx( ) the STA Manager 2508 passes the data to runtime and hardware resources 2504 to complete the API function call.

Similarly, as illustrated FIG. 26, resiliency operations may be performed by a resiliency portion of the STA Manager 2508 to process local resiliency operations, or the STA Manager 2508 may use a RaaS at the edge or cloud to perform resiliency operations on resources managed at the edge or cloud level.

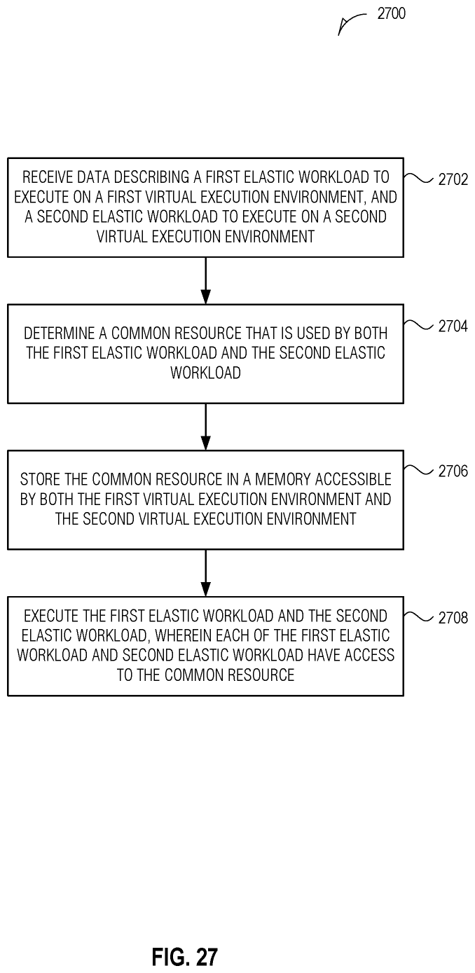

FIG. 27 is a flowchart illustrating a method 2700 for managing security, trust, and resiliency in elastic workloads, according to an example. The method 2700 may be performed by a device, such as a computing device like a compute node 3300 or an Edge computing node 3350.

At 2702, the method 2700 includes receiving data describing a first elastic workload to execute on a first virtual execution environment, and a second elastic workload to execute on a second virtual execution environment. The first and second virtual execution environments are associated with respective first and second security contexts. In an embodiment, the first virtual execution environment includes a first virtual machine tenant. In a related embodiment, the second virtual execution environment includes a second virtual machine tenant.

At 2704, the method 2700 includes determining a common resource that is used by both the first elastic workload and the second elastic workload. In embodiments, the common resource includes a function, a microservice, a library function, or public data.

In an embodiment, determining the common resource includes analyzing first code of the first elastic workload and second code of the second elastic workload to identify a function reference that is common to both the first code and the second code. In a further embodiment, the function reference is a Named Function Networking (NFN) expression.

In an embodiment, determining the common resource includes analyzing first code of the first elastic workload and second code of the second elastic workload to identify a data reference that is common to both the first code and the second code. In a further embodiment, the data reference is a Named Data Networking (NDN) expression.

At 2706, the method 2700 includes storing the common resource in a memory accessible by both the first virtual execution environment and the second virtual execution environment.

At 2708, the method 2700 includes executing the first elastic workload and the second elastic workload, wherein each of the first elastic workload and second elastic workload have access to the common resource, and wherein the first elastic workload and second elastic workload are executed in isolation from one another based on the first and second security contexts. In an embodiment, executing the first elastic workload and the second elastic workload includes alternating execution of the first and second elastic workloads.

In an embodiment, the method 2700 includes updating a security pointer from the first security context to the second security context, when executing the first elastic workload in the first security context to executing the second elastic workload in the second security context.

In an embodiment, the method 2700 includes clearing cache lines of the first elastic workload before executing the second elastic workload, when switching from the first security context to the second security context.

In an embodiment, the method 2700 includes detecting an application programming interface (API) call made by the first elastic workload, where the API is used to act on a resource, and where a parameter of the API call includes a token, the token including security, trust, or resiliency directives to apply to the resource. The method 2700 also includes determining that the security, trust, or resiliency directives are satisfied before allowing the API call access to the resource.

In an embodiment, the method 2700 includes detecting an application programming interface (API) call made by the first elastic workload, where the API is used to act on a resource, and where a parameter of the API call includes a service level agreement. The method 2700 also includes determining that the service level agreement is satisfied before allowing the API call access to the resource.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.
Example 1 is a data center system, comprising: a plurality of compute nodes; and a computing device configured to: receive data describing a first elastic workload to execute on a first virtual execution environment, and a second elastic workload to execute on a second virtual execution environment, the first and second virtual execution environments associated with respective first and second security contexts; determine a common resource that is used by both the first elastic workload and the second elastic workload; store the common resource in a memory accessible by both the first virtual execution environment and the second virtual execution environment; and execute the first elastic workload and the second elastic workload, wherein each of the first elastic workload and second elastic workload have access to the common resource, and wherein the first elastic workload and second elastic workload are executed in isolation from one another based on the first and second security contexts.
In Example 2, the subject matter of Example 1 includes, wherein the first virtual execution environment includes a first virtual machine tenant.
In Example 3, the subject matter of Examples 1-2 includes, wherein the second virtual execution environment includes a second virtual machine tenant.
In Example 4, the subject matter of Examples 1-3 includes, wherein the common resource includes a function.
In Example 5, the subject matter of Examples 1-4 includes, wherein the common resource includes a microservice.
In Example 6, the subject matter of Examples 1-5 includes, wherein the common resource includes a library function.
In Example 7, the subject matter of Examples 1-6 includes, wherein the common resource includes public data.
In Example 8, the subject matter of Examples 1-7 includes, wherein to determine the common resource, the computing device is to analyze first code of the first elastic workload and second code of the second elastic workload to identify a function reference that is common to both the first code and the second code.
In Example 9, the subject matter of Example 8 includes, wherein the function reference is a Named Function Networking (NFN) expression.
In Example 10, the subject matter of Examples 1-9 includes, wherein to determine the common resource, the computing device is to analyze first code of the first elastic workload and second code of the second elastic workload to identify a data reference that is common to both the first code and the second code.
In Example 11, the subject matter of Example 10 includes, wherein the data reference is a Named Data Networking (NDN) expression.
In Example 12, the subject matter of Examples 1-11 includes, wherein the computing device is to: update a security pointer from the first security context to the second security context, when executing the first elastic workload in the first security context to executing the second elastic workload in the second security context.
In Example 13, the subject matter of Examples 1-12 includes, wherein the computing device is to: clear cache lines of the first elastic workload before executing the second elastic workload, when switching from the first security context to the second security context.
In Example 14, the subject matter of Examples 1-13 includes, wherein to execute the first elastic workload and the second elastic workload, the computing device is to alternate execution of the first and second elastic workloads.
In Example 15, the subject matter of Examples 1-14 includes, wherein the computing device is to: detect an application programming interface (API) call made by the first elastic workload, wherein the API is used to act on a resource, and wherein a parameter of the API call includes a token, the token including security, trust, or resiliency directives to apply to the resource; and determine that the security, trust, or resiliency directives are satisfied before allowing the API call access to the resource.
In Example 16, the subject matter of Examples 1-15 includes, wherein the computing device is to: detect an application programming interface (API) call made by the first elastic workload, wherein the API is used to act on a resource, and wherein a parameter of the API call includes a service level agreement; and determine that the service level agreement is satisfied before allowing the API call access to the resource.
Example 17 is a method performed by a computing device in a data center system, comprising: receiving data describing a first elastic workload to execute on a first virtual execution environment, and a second elastic workload to execute on a second virtual execution environment, the first and second virtual execution environments associated with respective first and second security contexts; determining a common resource that is used by both the first elastic workload and the second elastic workload; storing the common resource in a memory accessible by both the first virtual execution environment and the second virtual execution environment; and executing the first elastic workload and the second elastic workload, wherein each of the first elastic workload and second elastic workload have access to the common resource, and wherein the first elastic workload and second elastic workload are executed in isolation from one another based on the first and second security contexts.
In Example 18, the subject matter of Example 17 includes, wherein the first virtual execution environment includes a first virtual machine tenant.
In Example 19, the subject matter of Examples 17-18 includes, wherein the second virtual execution environment includes a second virtual machine tenant.
In Example 20, the subject matter of Examples 17-19 includes, wherein the common resource includes a function.
In Example 21, the subject matter of Examples 17-20 includes, wherein the common resource includes a microservice.
In Example 22, the subject matter of Examples 17-21 includes, wherein the common resource includes a library function.
In Example 23, the subject matter of Examples 17-22 includes, wherein the common resource includes public data.
In Example 24, the subject matter of Examples 17-23 includes, wherein determining the common resource comprises analyzing first code of the first elastic workload and second code of the second elastic workload to identify a function reference that is common to both the first code and the second code.
In Example 25, the subject matter of Example 24 includes, wherein the function reference is a Named Function Networking (NFN) expression.
In Example 26, the subject matter of Examples 17-25 includes, wherein determining the common resource comprises analyzing first code of the first elastic workload and second code of the second elastic workload to identify a data reference that is common to both the first code and the second code.
In Example 27, the subject matter of Example 26 includes, wherein the data reference is a Named Data Networking (NDN) expression.
In Example 28, the subject matter of Examples 17-27 includes, updating a security pointer from the first security context to the second security context, when executing the first elastic workload in the first security context to executing the second elastic workload in the second security context.
In Example 29, the subject matter of Examples 17-28 includes, clearing cache lines of the first elastic workload before executing the second elastic workload, when switching from the first security context to the second security context.
In Example 30, the subject matter of Examples 17-29 includes, wherein executing the first elastic workload and the second elastic workload comprises alternating execution of the first and second elastic workloads.
In Example 31, the subject matter of Examples 17-30 includes, detecting an application programming interface (API) call made by the first elastic workload, wherein the API is used to act on a resource, and wherein a parameter of the API call includes a token, the token including security, trust, or resiliency directives to apply to the resource; and determining that the security, trust, or resiliency directives are satisfied before allowing the API call access to the resource.
In Example 32, the subject matter of Examples 17-31 includes, detecting an application programming interface (API) call made by the first elastic workload, wherein the API is used to act on a resource, and wherein a parameter of the API call includes a service level agreement; and determining that the service level agreement is satisfied before allowing the API call access to the resource.
Example 33 is at least one non-transitory machine-readable medium including instructions, which when executed by a computing device in a data center system, cause the computing device to: receive data describing a first elastic workload to execute on a first virtual execution environment, and a second elastic workload to execute on a second virtual execution environment, the first and second virtual execution environments associated with respective first and second security contexts; determine a common resource that is used by both the first elastic workload and the second elastic workload; store the common resource in a memory accessible by both the first virtual execution environment and the second virtual execution environment; and execute the first elastic workload and the second elastic workload, wherein each of the first elastic workload and second elastic workload have access to the common resource, and wherein the first elastic workload and second elastic workload are executed in isolation from one another based on the first and second security contexts.
In Example 34, the subject matter of Example 33 includes, wherein the first virtual execution environment includes a first virtual machine tenant.
In Example 35, the subject matter of Examples 33-34 includes, wherein the second virtual execution environment includes a second virtual machine tenant.
In Example 36, the subject matter of Examples 33-35 includes, wherein the common resource includes a function.
In Example 37, the subject matter of Examples 33-36 includes, wherein the common resource includes a microservice.
In Example 38, the subject matter of Examples 33-37 includes, wherein the common resource includes a library function.
In Example 39, the subject matter of Examples 33-38 includes, wherein the common resource includes public data.
In Example 40, the subject matter of Examples 33-39 includes, wherein to determine the common resource, the instructions cause the computing device is to analyze first code of the first elastic workload and second code of the second elastic workload to identify a function reference that is common to both the first code and the second code.
In Example 41, the subject matter of Example 40 includes, wherein the function reference is a Named Function Networking (NFN) expression.
In Example 42, the subject matter of Examples 33-41 includes, wherein to determine the common resource, the instructions cause the computing device is to analyze first code of the first elastic workload and second code of the second elastic workload to identify a data reference that is common to both the first code and the second code.
In Example 43, the subject matter of Example 42 includes, wherein the data reference is a Named Data Networking (NDN) expression.
In Example 44, the subject matter of Examples 33-43 includes, instructions that cause the computing device to: update a security pointer from the first security context to the second security context, when executing the first elastic workload in the first security context to executing the second elastic workload in the second security context.
In Example 45, the subject matter of Examples 33-44 includes, instructions that cause the computing device to: clear cache lines of the first elastic workload before executing the second elastic workload, when switching from the first security context to the second security context.
In Example 46, the subject matter of Examples 33-45 includes, wherein to execute the first elastic workload and the second elastic workload, the computing device is to alternate execution of the first and second elastic workloads.
In Example 47, the subject matter of Examples 33-46 includes, instructions that cause the computing device to: detect an application programming interface (API) call made by the first elastic workload, wherein the API is used to act on a resource, and wherein a parameter of the API call includes a token, the token including security, trust, or resiliency directives to apply to the resource; and determine that the security, trust, or resiliency directives are satisfied before allowing the API call access to the resource.
In Example 48, the subject matter of Examples 33-47 includes, instructions that cause the computing device to: detect an application programming interface (API) call made by the first elastic workload, wherein the API is used to act on a resource, and wherein a parameter of the API call includes a service level agreement; and determine that the service level agreement is satisfied before allowing the API call access to the resource.
Example 49 is at least one machine-readable medium including instructions that, when executed by processing circuitry, cause the processing circuitry to perform operations to implement of any of Examples 1-48.
Example 50 is an apparatus comprising means to implement of any of Examples 1-48.
Example 51 is a system to implement of any of Examples 1-48.
Example 52 is a method to implement of any of Examples 1-48.

### Overview of Edge Computing Environments

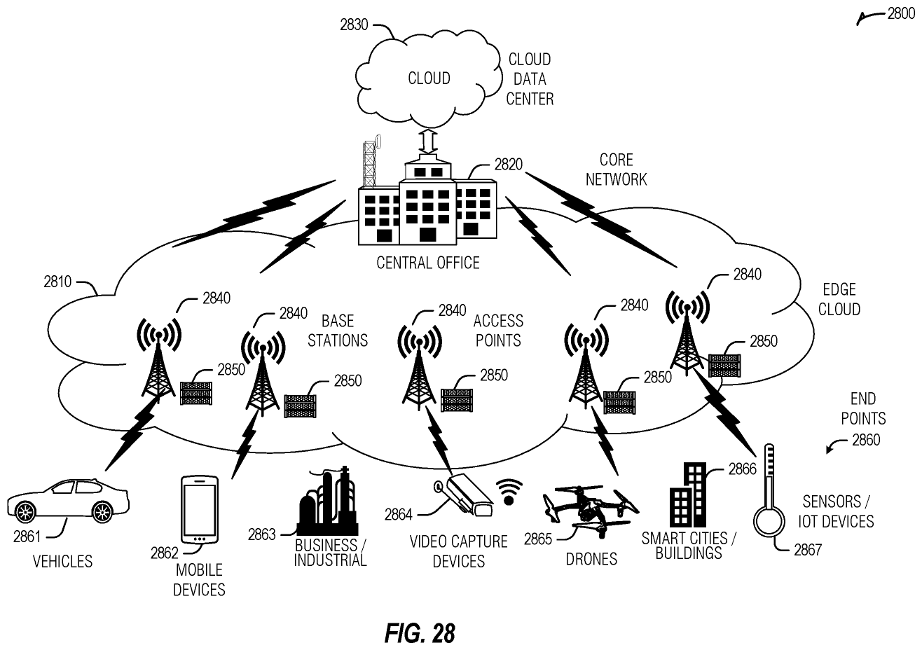

FIG. 28 is a block diagram 2800 showing an overview of a configuration for edge computing, which includes a layer of processing referenced in many of the current examples as an “edge cloud.” As shown, the edge cloud 2810 is co-located at an edge location, such as an access point or base station 2840, a local processing hub 2850, or a central office 2820, and thus may include multiple entities, devices, and equipment instances. The edge cloud 2810 is located much closer to the endpoint (consumer and producer) data sources 2860 (e.g., autonomous vehicles 2861, user equipment 2862, business and industrial equipment 2863, video capture devices 2864, mobile vehicles (e.g., drones) 2865, smart cities and building devices 2866, sensors and IoT devices 2867, etc.) than the cloud data center 2830. Compute, memory, and storage resources which are offered at the edges in the edge cloud 2810 are critical to providing ultra-low latency response times for services and functions used by the endpoint data sources 2860 as well as reduce network backhaul traffic from the edge cloud 2810 toward cloud data center 2830 thus improving energy consumption and overall network usages among other benefits.

Compute, memory, and storage are scarce resources, and generally, decrease depending on the edge location (e.g., fewer processing resources being available at consumer end point devices than at a base station or at a central office). However, the closer that the edge location is to the endpoint (e.g., UEs), the more that space and power are constrained. Thus, edge computing, as a general design principle, attempts to minimize the resources needed for network services, through the distribution of more resources which are located closer both geographically and in-network access time. In this manner, edge computing attempts to bring the compute resources to the workload data where appropriate, or bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge,” “close edge,” “local edge,” “middle edge,” or “far edge” layers, depending on latency, distance, and timing characteristics.

Edge computing is a developing paradigm where computing is performed at or closer to the “edge” of a network, typically through the use of a compute platform (e.g., x86, AMD or ARM hardware architectures) implemented at base stations, gateways, network routers, or other devices which are much closer to end point devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with compute hardware that performs virtualized network functions and offers compute resources for the execution of services and consumer functions for connected devices. Within edge computing networks, there may be scenarios in services in which the compute resource will be “moved” to the data, as well as scenarios in which the data will be “moved” to the compute resource. Or as an example, base station compute, acceleration and network resources can provide services to scale to workload demands on an as-needed basis by activating dormant capacity (subscription, capacity-on-demand) to manage corner cases, emergencies or to provide longevity for deployed resources over a significantly longer implemented lifecycle.

In contrast to the network architecture of FIG. 28, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage but is not optimal for highly time-varying data, such as a collision, traffic light change, etc. and may fail in attempting to meet latency challenges.

Depending on the real-time requirements in a communications context, a hierarchical structure of data processing and storage nodes may be defined in an edge computing deployment. For example, such a deployment may include local ultra-low-latency processing, regional storage, and processing as well as remote cloud data center-based storage and processing. Key performance indicators (KPIs) may be used to identify where sensor data is appropriately transferred and where it is processed or stored. This typically depends on the ISO layer dependency of the data. For example, lower layer (PHY, MAC, routing, etc.) data typically changes quickly and is better handled locally to meet latency requirements. Higher layer data such as Application-Layer data is typically less time-critical and may be stored and processed in a remote cloud data center.

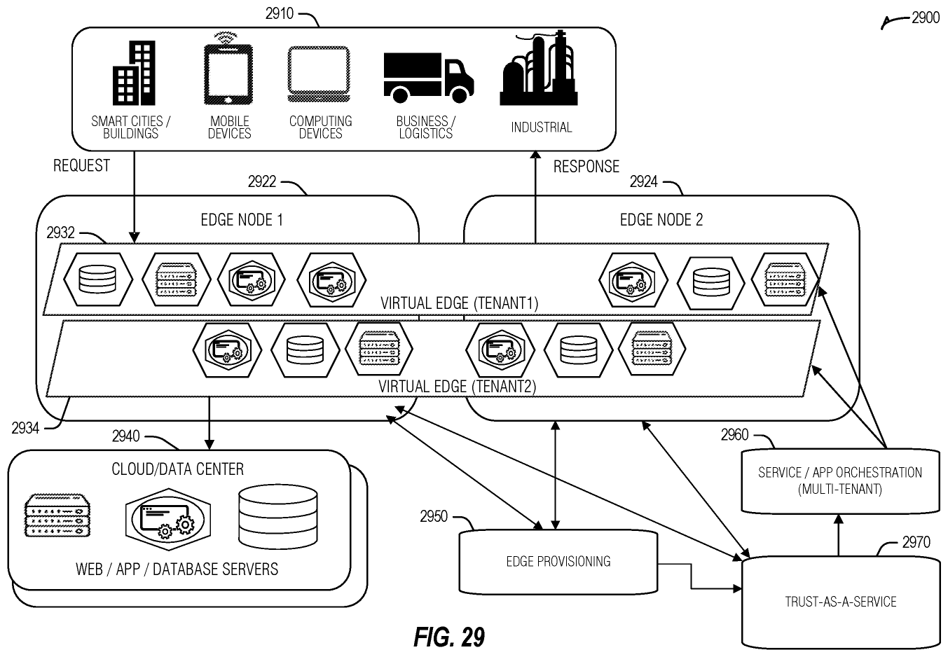

FIG. 29 illustrates deployment and orchestration for virtual edge configurations across an edge computing system operated among multiple edge nodes and multiple tenants. Specifically, FIG. 29 depicts coordination of a first edge node 2922 and a second edge node 2924 in an edge computing system 2900, to fulfill requests and responses for various client endpoints 2910 (e.g., smart cities/building systems, mobile devices, computing devices, business/logistics systems, industrial systems, etc.), which access various virtual edge instances. The virtual edge instances 2932, 2934 (or virtual edges) provide edge compute capabilities and processing in an edge cloud, with access to a cloud/data center 2940 for higher-latency requests for websites, applications, database servers, etc. Thus, the edge cloud enables coordination of processing among multiple edge nodes for multiple tenants or entities.

In the example of FIG. 29, these virtual edge instances include a first virtual edge 2932, offered to a first tenant (Tenant 1), which offers a first combination of edge storage, computing, and services; and a second virtual edge 2934, offering a second combination of edge storage, computing, and services, to a second tenant (Tenant 2). The virtual edge instances 2932, 2934 are distributed among the edge nodes 2922, 2924, and may include scenarios in which a request and response are fulfilled from the same or different edge nodes. The configuration of the individual edge nodes 2922, 2924 to operate in a distributed yet coordinated fashion occurs based on edge provisioning functions 2950. The functionality of the edge nodes 2922, 2924 to provide coordinated operation for applications and services, among multiple tenants, occurs based on orchestration functions 2960.

It should be understood that some of the devices in 2910 are multi-tenant devices where Tenant1 may function within a Tenant1 ‘slice’ while a Tenant2 may function within a Tenant2 ‘slice’ (and, in further examples, additional or sub-tenants may exist; and a respective tenant may be specifically entitled and transactionally tied to a specific set of features all the way to specific hardware features). A trusted multi-tenant device may further contain a tenant-specific cryptographic key such that the combination of a key and a slice may be considered a “root of trust” (RoT) or tenant-specific RoT. A ROT may further be computed dynamically composed using a compute security architecture, such as a DICE (Device Identity Composition Engine) architecture where a DICE hardware building block is used to construct layered trusted computing base contexts for secured and authenticated layering of device capabilities (such as with use of a Field Programmable Gate Array (FPGA)). The ROT also may be used for a trusted computing context to support respective tenant operations, etc. Use of this ROT and the compute security architecture may be enhanced by the attestation operations further discussed herein.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS (function as a service) engines, servlets, servers, or other computation abstraction may be partitioned according to a DICE layering and fan-out structure to support a RoT context for each. Accordingly, the respective RoTs spanning devices in 2910, 2922, and 2940 may coordinate the establishment of a distributed trusted computing base (DTCB) such that a tenant-specific virtual trusted secure channel linking all elements end-to-end can be established.

Further, it will be understood that a container may have data or workload-specific keys protecting its content from a previous edge node. As part of the migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

As an example, the edge computing system may be extended to provide orchestration of multiple applications through the use of containers (a contained, deployable unit of software that provides code and needed dependencies), in a multi-owner, multi-tenant environment. A multi-tenant orchestrator may be used to perform key management, trust anchor management, and other compute security functions related to the provisioning and lifecycle of the trusted ‘slice’ concept in FIG. 29. An orchestrator may use a DICE layering and fan-out construction to create a root of trust context that is tenant specific. Thus, orchestration functions, provided by an orchestrator, may participate as a tenant-specific orchestration provider.

Accordingly, an edge-computing system may be configured to fulfill requests and responses for various client endpoints from multiple virtual edge instances (and, from a cloud or remote data center, not shown). The use of these virtual edge instances supports multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications, latency-sensitive applications, latency-critical applications, user plane applications, networking applications, etc.). The virtual edge instances may also be spanned across systems of multiple owners at different geographic locations (or respective computing systems and resources which are co-owned or co-managed by multiple owners).

For instance, a respective edge node 2922, 2924 may implement the use of containers, such as with the use of a container “pod” 2926, 2928 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices of virtual edges 2932, 2934 are partitioned according to the needs of a respective container.

With the use of container pods, a pod controller oversees the partitioning and allocation of containers and resources. The pod controller receives instructions from an orchestrator (e.g., performing orchestration functions 2960) that instructs the controller on how to appropriately partition physical resources and for what duration, such as by receiving key performance indicator (KPI) targets based on SLA contracts. The pod controller determines which container uses which resources and for how long to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a compute security role that prevents the assignment of resources until the right tenant authenticates or prevents provisioning of data or a workload to a container until an attestation result is satisfied.

Also, with the use of container pods, tenant boundaries can still exist but in the context of a respective pod of containers. If a respective tenant-specific pod has a tenant-specific pod controller, there may be a shared pod controller that consolidates resource allocation requests to avoid typical resource starvation situations. Further controls may be provided to ensure the attestation and trustworthiness of the pod and pod controller. For instance, the orchestrator 2960 may provision an attestation verification policy, a security verification policy, or a trust verification policy to local pod controllers that perform verification. If an attestation, security profile, or trust profile satisfy a corresponding policy for a first tenant pod controller but not a second tenant pod controller, then the second pod may be migrated to a different edge node that does satisfy it. Alternatively, the first pod may be allowed to execute, and a different shared pod controller is installed and invoked before the second pod executing.

In further examples, edge computing systems may deploy containers in an edge computing system. As a simplified example, a container manager is adapted to launch containerized pods, functions, and functions-as-a-service instances through execution via compute nodes, or to separately execute containerized virtualized network functions through execution via compute nodes. This arrangement may be adapted for use by multiple tenants in system arrangement, where containerized pods, functions, and functions-as-a-service instances are launched within virtual machines specific to an individual tenant (aside from the execution of virtualized network functions).

Within the edge cloud, a first edge node 2922 (e.g., operated by a first owner) and a second edge node 2924 (e.g., operated by a second owner) may operate or respond to a container orchestrator to coordinate the execution of various applications within the virtual edge instances offered for respective tenants. For instance, the edge nodes 2922, 2924 may be coordinated based on edge provisioning functions 2950, while the operation of the various applications is coordinated with orchestration functions 2960.

Various system arrangements may provide an architecture that treats VMs, Containers, and Functions equally in terms of application composition (and resulting applications are combinations of these three ingredients). A respective ingredient may involve the use of one or more accelerator (e.g., FPGA, ASIC, cryptographic execution) components as a local backend. In this manner, applications can be split across multiple edge owners, coordinated by an orchestrator.

Trust, security, or reliability metrics may be generated for edge nodes 2922, 2924 as they are composed. The edge provisioning functions 2950 or orchestration functions 2960 may be used to control deployment of workloads to edge nodes that satisfy security, trust, resiliency, or attestation requirements. The edge nodes 2922, 2924 may be reassessed periodically or intermittently to ensure that they continue to provide an execution environment that satisfies security, trust, resiliency, or attestation requirements. For instance, when new vulnerabilities are discovered, the edge nodes 2922, 2924 may be reassessed. The edge nodes 2922, 2924 may also be monitored for signs of malicious behavior, common vulnerabilities and exposures (CVE), or other suspicious behavior. Workloads may be migrated, halted, or isolated on edge nodes that exhibit security, operational, or reliability concerns. An isolated workload does not have access to resources used by another workload.

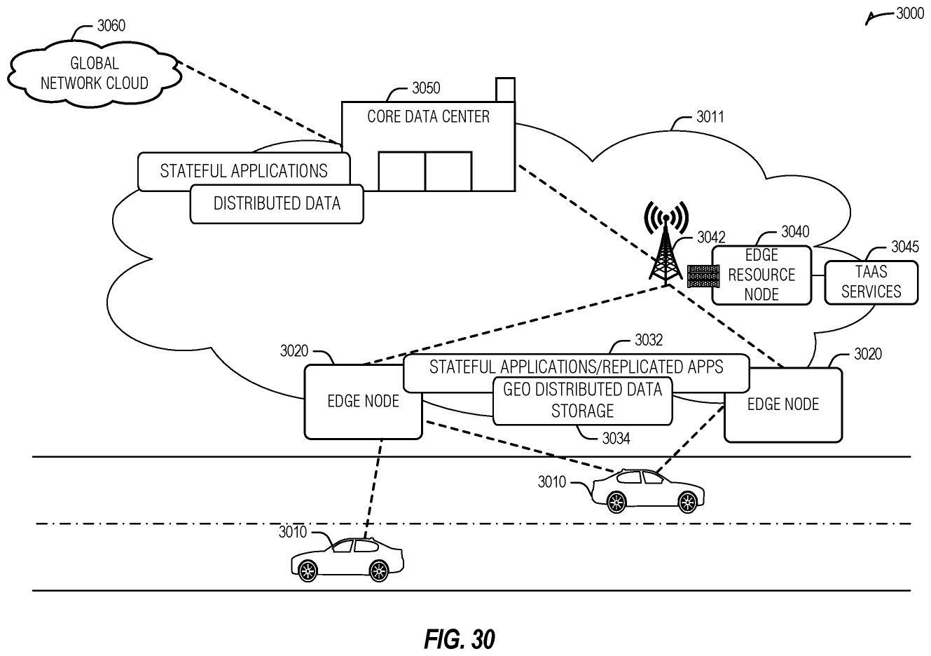

It should be appreciated that the edge computing systems and arrangements discussed herein may be applicable in various solutions, services, and/or use cases. As an example, FIG. 30 shows a simplified vehicle compute and communication use case involving mobile access to applications in an edge computing system 3000 that implements an edge cloud 2810 connected to Trust-as-a-Service (TaaS) instances 3045. In this use case, a client compute node 3010 may be embodied as in-vehicle compute systems (e.g., in-vehicle navigation and/or infotainment systems) located in corresponding vehicles that communicate with the edge gateway nodes 3020 during traversal of a roadway. For instance, edge gateway nodes 3020 may be located in roadside cabinets, which may be placed along the roadway, at intersections of the roadway, or other locations near the roadway. As a vehicle traverses along the roadway, the connection between its client compute node 3010 and a particular edge gateway node 3020 may propagate to maintain a consistent connection and context for the client compute node 3010. The respective nodes of the edge gateway nodes 3020 includes some processing and storage capabilities and, as such, some processing and/or storage of data for the client compute nodes 3010 may be performed on one or more of the edge gateway nodes 3020.

A respective node of the edge gateway nodes 3020 may communicate with one or more edge resource nodes 3040, which are illustratively embodied as compute servers, appliances or components located at or in a communication base station 3042 (e.g., a base station of a cellular network). As discussed above, a respective edge resource node 3040 includes some processing and storage capabilities, and, as such, some processing and/or storage of data for the client compute nodes 3010 may be performed on the edge resource node 3040. For example, the processing of data that is less urgent or important may be performed by the edge resource node 3040, while the processing of data that is of a higher urgency or importance may be performed by edge gateway devices or the client nodes themselves (depending on, for example, the capabilities of a respective component). Further, various wired or wireless communication links (e.g., fiber optic wired backhaul, 5G wireless links) may exist among the edge nodes 3020, edge resource node(s) 3040, core data center 3050, and network cloud 3060.

The edge resource node(s) 3040 also communicate with the core data center 3050, which may include compute servers, appliances, and/or other components located in a central location (e.g., a central office of a cellular communication network). The core data center 3050 may provide a gateway to the global network cloud 3060 (e.g., the Internet) for the edge cloud 3011 (e.g., edge cloud 2810) operations formed by the edge resource node(s) 3040 and the edge gateway nodes 3020. Additionally, in some examples, the core data center 3050 may include an amount of processing and storage capabilities and, as such, some processing and/or storage of data for the client compute devices may be performed on the core data center 3050 (e.g., processing of low urgency or importance, or high complexity). The edge gateway nodes 3020 or the edge resource nodes 3040 may offer the use of stateful applications 3032 and a geographically distributed data storage 3034 (e.g., database, data store, etc.).

In further examples, FIG. 30 may utilize various types of mobile edge nodes, such as an edge node hosted in a vehicle (e.g., car, truck, tram, train, etc.) or other mobile units, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in a variety of settings, including coordination between some functions or operations at individual endpoint devices or the edge gateway nodes 3020, some others at the edge resource node 3040, and others in the core data center 3050 or the global network cloud 3060.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code is executed. The container may be any isolated-execution entity (a workload execution environment) such as a process, a Docker or Kubernetes container, a virtual machine, etc. Within the edge computing system, various data center, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, the container is “spun down” (e.g., deactivated and/or deallocated) on the infrastructure in response to the execution being completed.

Further aspects of FaaS may enable deployment of edge functions in a service fashion, including support of respective functions that support edge computing as a service. Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require deployment or configuration).

### Example Internet of Things Architectures

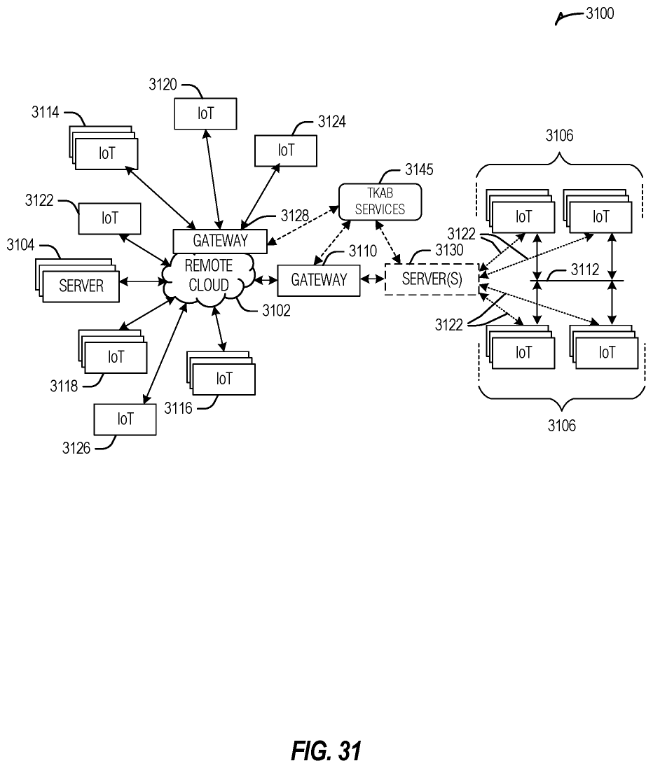

As a more detailed illustration of an Internet of Things (IOT) network, FIG. 31 illustrates a drawing of a cloud or edge computing network 3100, in communication with several IoT devices and a TaaS instance 3145. The IoT is a concept in which a large number of computing devices are interconnected with one other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar (or lower) cost compared to the cost of smaller numbers of larger devices. However, an IoT device may be a smartphone, laptop, tablet, or PC, or other larger device. Further, an IoT device may be a virtual device, such as an application on a smartphone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

Returning to FIG. 31, the network 3100 may represent portions of the Internet or may include portions of a local area network (LAN), or a wide area network (WAN), such as a proprietary network for a company. The IoT devices may include any number of different types of devices, grouped in various combinations. For example, a traffic control group 3106 may include IoT devices along streets in a city. These IoT devices may include stoplights, traffic flow monitors, cameras, weather sensors, and the like. The traffic control group 3106, or other subgroups, may be in communication within the network 3100 through wired or wireless links 3108, such as LPWA links, optical links, and the like. Further, a wired or wireless sub-network 3112 may allow the IoT devices to communicate with one another, such as through a local area network, a wireless local area network, and the like. The IoT devices may use another device, such as a gateway 3110 or 3128 to communicate with remote locations such as remote cloud 3102; the IoT devices may also use one or more servers 3130 to facilitate communication within the network 3100 or with the gateway 3110. For example, the one or more servers 3130 may operate as an intermediate network node to support a local edge cloud or fog implementation among a local area network. Further, the gateway 3128 that is depicted may operate in a cloud-to-gateway-to-many edge devices configuration, such as with the various IoT devices 3114, 3120, 3124 being constrained or dynamic to an assignment and use of resources in the network 3100.

In an example embodiment, the network 3100 can further include or be communicatively coupled to a Trust-a-a-Service instance or deployment configured to perform trust attestation operations within the network 3100, such as that discussed above.

Other example groups of IoT devices may include remote weather stations 3114, local information terminals 3116, alarm systems 3118, automated teller machines 3120, alarm panels 3122, or moving vehicles, such as emergency vehicles 3124 or other vehicles 3126, among many others. These IoT devices may be in communication with other IoT devices, with servers 3104, with another IoT device or system, another edge computing or “fog” computing system, or a combination therein. The groups of IoT devices may be deployed in various residential, commercial, and industrial settings (including in both private or public environments).

As may be seen from FIG. 31, a large number of IoT devices may be communicating through the network 3100. This may allow different IoT devices to request or provide information to other devices autonomously. For example, a group of IoT devices (e.g., the traffic control group 3106) may request a current weather forecast from a group of remote weather stations 3114, which may provide the forecast without human intervention. Further, an emergency vehicle 3124 may be alerted by an automated teller machine 3120 that a burglary is in progress. As the emergency vehicle 3124 proceeds towards the automated teller machine 3120, it may access the traffic control group 3106 to request clearance to the location, for example, by lights turning red to block cross traffic at an intersection in sufficient time for the emergency vehicle 3124 to have unimpeded access to the intersection.

Clusters of IoT devices may be equipped to communicate with other IoT devices as well as with a cloud network. This may allow the IoT devices to form an ad-hoc network between the devices, allowing them to function as a single device, which may be termed a fog device or system. Clusters of IoT devices, such as may be provided by the remote weather stations 3114 or the traffic control group 3106, may be equipped to communicate with other IoT devices as well as with the network 3100. This may allow the IoT devices to form an ad-hoc network between the devices, allowing them to function as a single device, which also may be termed a fog device or system.

In further examples, a variety of topologies may be used for IoT networks comprising IoT devices, with the IoT networks coupled through backbone links to respective gateways. For example, a number of IoT devices may communicate with a gateway, and with each other through the gateway. The backbone links may include any number of wired or wireless technologies, including optical networks, and may be part of a local area network (LAN), a wide area network (WAN), or the Internet. Additionally, such communication links facilitate optical signal paths among both IoT devices and gateways, including the use of MUXing/deMUXing components that facilitate the interconnection of the various devices.

The network topology may include any number of types of IoT networks, such as a mesh network provided with the network using Bluetooth low energy (BLE) links. Other types of IoT networks that may be present include a wireless local area network (WLAN) network used to communicate with IoT devices through IEEE 802.11 (Wi-Fi®) links, a cellular network used to communicate with IoT devices through an LTE/LTE-A (4G) or 5G cellular network, and a low-power wide-area (LPWA) network, for example, a LPWA network compatible with the LoRaWan specification promulgated by the LoRa alliance, or an IPV6 over Low Power Wide-Area Networks (LPWAN) network compatible with a specification promulgated by the Internet Engineering Task Force (IETF).

Further, the respective IoT networks may communicate with an outside network provider (e.g., a tier 2 or tier 3 provider) using any number of communications links, such as an LTE cellular link, a LPWA link, or a link based on the IEEE 802.15.4 standard, such as Zigbee®. The respective IoT networks may also operate with the use of a variety of network and internet application protocols such as the Constrained Application Protocol (CoAP). The respective IoT networks may also be integrated with coordinator devices that provide a chain of links that forms a cluster tree of linked devices and networks.

IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration, and quality of service (QOS) based swarming and coordination/combinations of resources.

An IoT network, arranged as a mesh network, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of the assets and resources. Furthermore, the proper components of infrastructure and resource-based trust and service indices may be inserted to improve the data integrity, quality, assurance, and deliver a metric of data confidence.

### Example Computing Devices

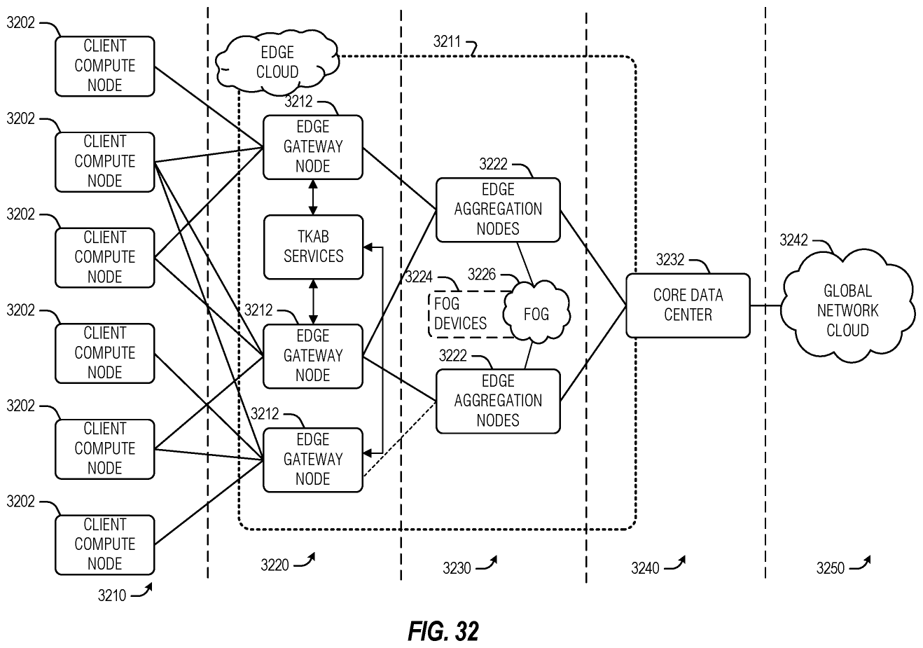

At a more generic level, an edge computing system may be described to encompass any number of deployments operating in the edge cloud 2810, which provide coordination from client and distributed computing devices. FIG. 32 provides a further abstracted overview of layers of distributed compute deployed among an edge computing environment for purposes of illustration.

FIG. 32 generically depicts an edge computing system for providing edge services and applications to multi-stakeholder entities, as distributed among one or more client compute nodes 3202, one or more edge gateway nodes 3212, one or more edge aggregation nodes 3222, one or more core data centers 3232, and a global network cloud 3242, as distributed across layers of the network. The implementation of the edge computing system may be provided at or on behalf of a telecommunication service provider (“telco” or “TSP”), internet-of-things service provider, a cloud service provider (CSP), enterprise entity, or any other number of entities. Various forms of wired or wireless connections may be configured to establish connectivity among the nodes 3202, 3212, 3222, 3232, including interconnections among such nodes (e.g., connections among edge gateway nodes 3212, and connections among edge aggregation nodes 3222). Such connectivity and federation of these nodes may be assisted with the use of TaaS services 3260 and service instances, as discussed herein.

A respective node or device of the edge computing system is located at a particular layer corresponding to layers 3210, 3220, 3230, 3240, and 3250. For example, the client compute nodes 3202 are located at an endpoint layer 3210, while the edge gateway nodes 3212 are located at an edge devices layer 3220 (local level) of the edge computing system. Additionally, the edge aggregation nodes 3222 (and/or fog devices 3224, if arranged or operated with or among a fog networking configuration 3226) is located at a network access layer 3230 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein apply to fog networks, fogging, and fog configurations. Further, aspects of the edge computing systems discussed herein may be configured as a fog, or aspects of a fog may be integrated into an edge computing architecture.

The core data center 3232 is located at a core network layer 3240 (e.g., a regional or geographically-central level), while the global network cloud 3242 is located at a cloud data center layer 3250 (e.g., a national or global layer). The use of “core” is provided as a term for a centralized network location—deeper in the network—which is accessible by multiple edge nodes or components; however, a “core” does not necessarily designate the “center” or the deepest location of the network. Accordingly, the core data center 3232 may be located within, at, or near the edge cloud 3211 (e.g., edge cloud 2810).

Although an illustrative number of client compute nodes 3202, edge gateway nodes 3212, edge aggregation nodes 3222, core data centers 3232, and global network clouds 3242 are shown in FIG. 32, it should be appreciated that the edge computing system may include more or fewer devices or systems at respective layers. Additionally, as shown in FIG. 32, the number of components of respective layers 3210, 3220, 3230, 3240, and 3250 generally increases at lower levels (e.g., when moving closer to endpoints). As such, one edge gateway node 3212 may service multiple client compute nodes 3202, and one edge aggregation node 3222 may service multiple edge gateway nodes 3212.

Consistent with the examples provided herein, a client compute node 3202 may be embodied as any type of end point component, device, appliance, or “thing” capable of communicating as a producer or consumer of data. Further, the label “node” or “device” as used in the edge computing system 3200 does not necessarily mean that such node or device operates in a client or minion/follower/agent role; rather, any of the nodes or devices in the edge computing system 3200 refer to individual entities, nodes, or subsystems which include discrete or connected hardware or software configurations to facilitate or use the edge cloud 3211.

As such, the edge cloud 3211 is formed from network components and functional features operated by and within the edge gateway nodes 3212 and the edge aggregation nodes 3222 of layers 3220, 3230, respectively. The edge cloud 3211 may be embodied as any type of network that provides edge computing and/or storage resources which are proximately located to radio access network (RAN) capable endpoint devices (e.g., mobile computing devices, IoT devices, smart devices, etc.), which are shown in FIG. 32 as the client compute nodes 3202. In other words, the edge cloud 3211 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 3211 may form a portion of or otherwise provide an ingress point into or across a fog networking configuration 3226 (e.g., a network of fog devices 3224, not shown in detail), which may be embodied as a system-level horizontal and distributed architecture that distributes resources and services to perform a specific function. For instance, a coordinated and distributed network of fog devices 3224 may perform computing, storage, control, or networking aspects in the context of an IoT system arrangement. Other networked, aggregated, and distributed functions may exist in the edge cloud 3211 between the cloud data center layer 3250 and the client endpoints (e.g., client compute nodes 3202). Some of these are discussed in the following sections in the context of network functions or service virtualization, including the use of virtual edges and virtual services which are orchestrated for multiple stakeholders.

The edge gateway nodes 3212 and the edge aggregation nodes 3222 cooperate to provide various edge services and compute security features to the client compute nodes 3202. Furthermore, because an individual client compute node 3202 may be stationary or mobile, a respective edge gateway node 3212 may cooperate with other edge gateway devices to propagate presently provided edge services and compute security features as the corresponding client compute node 3202 moves about a region. To do so, respective nodes of the edge gateway nodes 3212 and/or edge aggregation nodes 3222 may support multiple tenancies and multiple stakeholder configurations, in which services from (or hosted for) multiple service providers and multiple consumers may be supported and coordinated across a single or multiple compute devices.

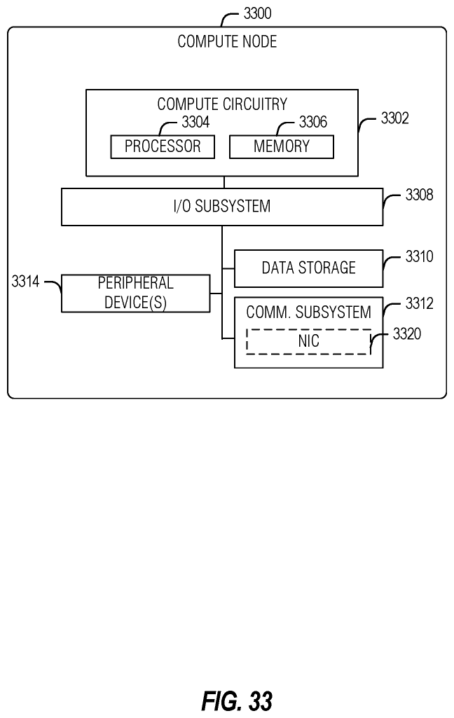

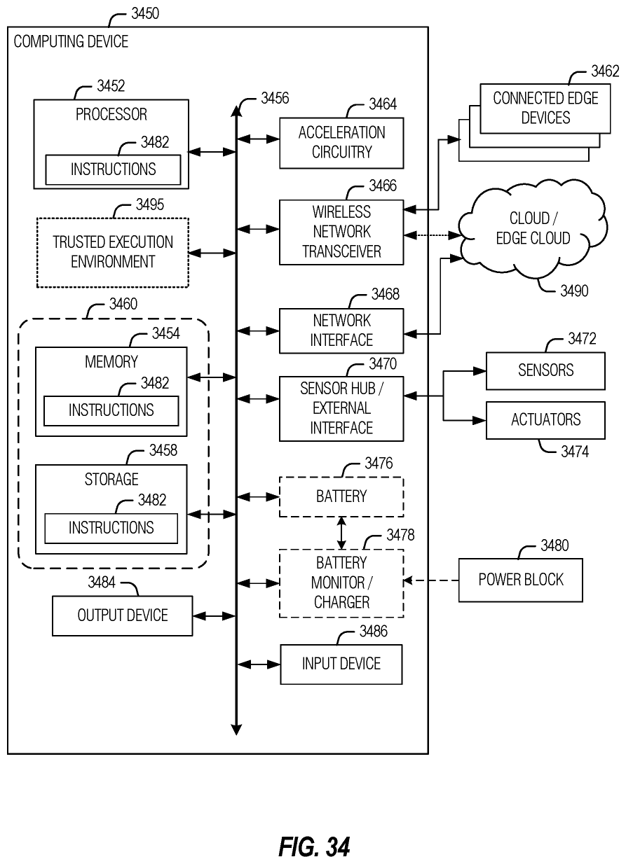

In further examples, any of the compute nodes or devices discussed with reference to the present edge computing systems and environment may be fulfilled based on the components depicted in FIGS. 33 and 34. An edge compute node may be embodied as a type of device, appliance, computer, or other “thing” capable of communicating with other edge, networking, or endpoint components. For example, an edge compute device may be embodied as a personal computer, a server, smartphone, a mobile compute device, a smart appliance, an in-vehicle compute system (e.g., a navigation system), a self-contained device having an outer case, shell, etc., or other devices or systems capable of performing the described functions.

In the simplified example depicted in FIG. 33, an edge compute node 3300 includes a compute engine (also referred to herein as “compute circuitry”) 3302, an input/output (I/O) subsystem 3308, data storage 3310, a communication circuitry subsystem 3312, and, optionally, one or more peripheral devices 3314. In other examples, a respective compute device may include other or additional components, such as those used in personal or server computing systems (e.g., a display, peripheral devices, etc.). Additionally, in some examples, one or more of the illustrative components may be incorporated in, or otherwise form a portion of, another component.

The compute node 3300 may be embodied as any type of engine, device, or collection of devices capable of performing various compute functions. In some examples, the compute node 3300 may be embodied as a single device such as an integrated circuit, an embedded system, a field-programmable gate array (FPGA), a system-on-a-chip (SOC), or other integrated system or device. In the illustrative example, the compute node 3300 includes or is embodied as a processor 3304 and a memory 3306. The processor 3304 may be embodied as any type of processor capable of performing the functions described herein (e.g., executing an application). For example, the processor 3304 may be embodied as a multi-core processor(s), a microcontroller, a processing unit, a specialized or special purpose processing unit, or other processor or processing/controlling circuit. In some examples, the processor 3304 may be embodied as, include, or be coupled to an FPGA, an application-specific integrated circuit (ASIC), reconfigurable hardware or hardware circuitry, or other specialized hardware to facilitate performance of the functions described herein. Also in some examples, the processor 3304 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), dedicated compute circuitry, storage devices, or AI or specialized hardware (e.g., GPUs, programmed FPGAs, Network Processing Units (NPUs), Infrastructure Processing Units (IPUs), Storage Processing Units (SPUs), AI Processors (APUs), Data Processing Units (DPUs), Edge Processing Units (EPUs), or other specialized compute units such as a cryptographic processing unit/accelerator). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. Thus, any of the C2E techniques described herein and their accompanying attestation, trust, security, provisioning, testing, simulation, or orchestration functions may be coordinated by an xPU. However, it will be understood that an xPU, a SOC, a CPU, and other variations of the processor 3304 may work in coordination with each other to execute many types of operations and instructions within and on behalf of the compute node 3300.

The main memory 3306 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three-dimensional crosspoint memory device (e.g., Intel® 3D XPoint™ memory), or other byte-addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross-point architecture in which memory cells sit at the intersection of word lines and bit lines and are individually addressable and in which bit storage is based on a change in bulk resistance. In some examples, all or a portion of the main memory 3306 may be integrated into the processor 3304. The main memory 3306 may store various software and data used during operation such as one or more applications, data operated on by the application(s), libraries, and drivers.

The compute circuitry 3302 is communicatively coupled to other components of the compute node 3300 via the I/O subsystem 3308, which may be embodied as circuitry and/or components to facilitate input/output operations with the compute circuitry 3302 (e.g., with the processor 3304 and/or the main memory 3306) and other components of the compute circuitry 3302. For example, the I/O subsystem 3308 may be embodied as, or otherwise include memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 3308 may form a portion of a system-on-a-chip (SoC) and be incorporated, along with one or more of the processor 3304, the main memory 3306, and other components of the compute circuitry 3302, into the compute circuitry 3302.

The one or more illustrative data storage devices 3310 may be embodied as any type of device configured for short-term or long-term storage of data such as, for example, memory devices and circuits, memory cards, hard disk drives, solid-state drives, or other data storage devices. A respective data storage device 3310 may include a system partition that stores data and firmware code for the data storage device 3310. A respective data storage device 3310 may also include one or more operating system partitions that store data files and executables for operating systems depending on, for example, the type of compute node 3300.

The communication circuitry 3312 may be embodied as any communication circuit, device, or collection thereof, capable of enabling communications over a network between the compute circuitry 3302 and another compute device (e.g., an edge gateway node 3212 of the edge computing system 3200). The communication circuitry 3312 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, an IoT protocol such as IEEE 802.15.4 or ZigBee®, low-power wide-area network (LPWAN) or low-power wide-area (LPWA) protocols, etc.) to effect such communication.

The illustrative communication circuitry 3312 includes a network interface controller (NIC) 3320, which may also be referred to as a host fabric interface (HFI). The NIC 3320 may be embodied as one or more add-in-boards, daughter cards, network interface cards, controller chips, chipsets, or other devices that may be used by the compute node 3300 to connect with another compute device (e.g., an edge gateway node 3212). In some examples, the NIC 3320 may be embodied as part of a system-on-a-chip (SoC) that includes one or more processors or included on a multichip package that also contains one or more processors. In some examples, the NIC 3320 may include a local processor (not shown) and/or a local memory and storage (not shown) that are local to the NIC 3320. In such examples, the local processor of the NIC 3320 (which can include general-purpose accelerators or specific accelerators) may be capable of performing one or more of the functions of the compute circuitry 3302 described herein. Additionally, or alternatively, the local memory of the NIC 3320 may be integrated into one or more components of the client compute node at the board level, socket level, chip level, and/or other levels.

Additionally, in some examples, a respective compute node 3300 may include one or more peripheral devices 3314. Such peripheral devices 3314 may include any type of peripheral device found in a compute device or server such as audio input devices, a display, other input/output devices, interface devices, and/or other peripheral devices, depending on the particular type of the compute node 3300. In further examples, the compute node 3300 may be embodied by a respective edge compute node in an edge computing system (e.g., client compute node 3202, edge gateway node 3212, edge aggregation node 3222) or like forms of appliances, computers, subsystems, circuitry, or other components.

In a more detailed example, FIG. 34 illustrates a block diagram of an example of components that may be present in an edge computing device (or node) 3450 for implementing the techniques (e.g., operations, processes, methods, and methodologies) described herein. The edge computing node 3450 provides a closer view of the respective components of node 3300 when implemented as or as part of a computing device (e.g., as a mobile device, a base station, server, gateway, etc.). The edge computing node 3450 may include any combinations of the components referenced above, and it may include any device usable with an edge communication network or a combination of such networks. The components may be implemented as integrated circuits (ICs), portions thereof, discrete electronic devices, or other modules, logic, instruction sets, programmable logic or algorithms, hardware, hardware accelerators, software, firmware, or a combination thereof adapted in the edge computing node 3450, or as components otherwise incorporated within a chassis of a larger system.

The edge computing node 3450 may include processing circuitry in the form of a processor 3452, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 3452 may be a part of a system on a chip (SoC) in which the processor 3452 and other components are formed into a single integrated circuit, or a single package, such as the Edison™ or Galileo™ SoC boards from Intel Corporation, Santa Clara, California. As an example, the processor 3452 may include an Intel® Architecture Core™ based processor, such as a Quark™, an Atom™, an i3, an i5, an i7, an i9, or an MCU-class processor, or another such processor available from Intel®. However, any number other processors may be used, such as available from Advanced Micro Devices, Inc. (AMD) of Sunnyvale, California, a MIPS-based design from MIPS Technologies, Inc. of Sunnyvale, California, an ARM-based design licensed from ARM Holdings, Ltd. or a customer thereof, or their licensees or adopters. The processors may include units such as an A5-A14 processor from Apple® Inc., a Snapdragon™ processor from Qualcomm® Technologies, Inc., or an OMAP™ processor from Texas Instruments, Inc. The processor 3452 and accompanying circuitry may be provided in a single socket form factor, multiple socket form factor, or a variety of other formats, including in limited hardware configurations or configurations that include fewer than all elements shown in FIG. 34.

The processor 3452 may communicate with a system memory 3454 over an interconnect 3456 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP), or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems, and so forth, a storage 3458 may also couple to the processor 3452 via the interconnect 3456. In an example, the storage 3458 may be implemented via a solid-state disk drive (SSDD). Other devices that may be used for the storage 3458 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin-transfer torque (STT)-MRAM, a spintronic magnetic junction memory-based device, a magnetic tunneling junction (MTJ) based device, a DW (Domain Wall) and SOT (Spin-Orbit Transfer) based device, a thyristor-based memory device, or a combination of any of the above, or other memory.

In low power implementations, the storage 3458 may be on-die memory or registers associated with the processor 3452. However, in some examples, the storage 3458 may be implemented using a micro hard disk drive (HDD) or solid-state drive (SSD). Further, any number of new technologies may be used for the storage 3458 in addition to, or instead of, the technologies described, such resistance change memories, phase change memories, holographic memories, or chemical memories, among others.

The components may communicate over the interconnect 3456. The interconnect 3456 may include any number of technologies, including industry-standard architecture (ISA), extended ISA (EISA), peripheral component interconnect (PCI), peripheral component interconnect extended (PCI-X), PCI express (PCIe), or any number of other technologies. The interconnect 3456 may be a proprietary bus, for example, used in an SoC based system. Other bus systems may be included, such as an I2C interface, an SPI interface, point to point interfaces, and a power bus, among others.

The interconnect 3456 may couple the processor 3452 to a transceiver 3466, for communications with the connected edge devices 3462. The transceiver 3466 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 3462. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 3466 (or multiple transceivers) may communicate using multiple standards or radios for communications at a different range. For example, the edge computing node 3450 may communicate with close devices, e.g., within about 10 meters, using a local transceiver based on BLE, or another low power radio, to save power. More distant connected edge devices 3462, e.g., within about 50 meters, may be reached over ZigBee or other intermediate power radios. Both communications techniques may take place over a single radio at different power levels or may take place over separate transceivers, for example, a local transceiver using BLE and a separate mesh transceiver using ZigBee®.

A wireless network transceiver 3466 (e.g., a radio transceiver) may be included to communicate with devices or services in the edge cloud 3490 via local or wide area network protocols. The wireless network transceiver 3466 may be an LPWA transceiver that follows the IEEE 802.15.4, or IEEE 802.15.4g standards, among others. The edge computing node 3450 may communicate over a wide area using LoRaWAN™ (Long Range Wide Area Network) developed by Semtech and the LoRa Alliance. The techniques described herein are not limited to these technologies but may be used with any number of other cloud transceivers that implement long-range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 3466, as described herein. For example, the transceiver 3466 may include a cellular transceiver that uses spread spectrum (SPA/SAS) communications for implementing high-speed communications. Further, any number of other protocols may be used, such as Wi-Fi® networks for medium speed communications and provision of network communications. The transceiver 3466 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 3468 may be included to provide a wired communication to nodes of the edge cloud 3490 or other devices, such as the connected edge devices 3462 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, Time Sensitive Networks (TSN), among many others. An additional NIC 3468 may be included to enable connecting to a second network, for example, a first NIC 3468 providing communications to the cloud over Ethernet, and a second NIC 3468 providing communications to other devices over another type of network.

Given the variety of types of applicable communications from the device to another component or network, applicable communications circuitry used by the device may include or be embodied by any one or more of components 3464, 3466, 3468, or 3470. Accordingly, in various examples, applicable means for communicating (e.g., receiving, transmitting, etc.) may be embodied by such communications circuitry.

The edge computing node 3450 may include or be coupled to acceleration circuitry 3464, which may be embodied by one or more AI accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. Accordingly, in various examples, applicable means for acceleration may be embodied by such acceleration circuitry.

The interconnect 3456 may couple the processor 3452 to a sensor hub or external interface 3470 that is used to connect additional devices or subsystems. The devices may include sensors 3472, such as accelerometers, level sensors, flow sensors, optical light sensors, camera sensors, temperature sensors, a global navigation system (e.g., GPS) sensors, pressure sensors, barometric pressure sensors, and the like. The hub or interface 3470 further may be used to connect the edge computing node 3450 to actuators 3474, such as power switches, valve actuators, an audible sound generator, a visual warning device, and the like.

In some optional examples, various input/output (I/O) devices may be present within or connected to, the edge computing node 3450. For example, a display or other output device 3484 may be included to show information, such as sensor readings or actuator position. An input device 3486, such as a touch screen or keypad may be included to accept input. An output device 3484 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the edge computing node 3450. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 3476 may power the edge computing node 3450, although, in examples in which the edge computing node 3450 is mounted in a fixed location, it may have a power supply coupled to an electrical grid, or the battery may be used as a backup or for temporary capabilities. The battery 3476 may be a lithium-ion battery, or a metal-air battery, such as a zinc-air battery, an aluminum-air battery, a lithium-air battery, and the like.

A battery monitor/charger 3478 may be included in the edge computing node 3450 to track the state of charge (SoCh) of the battery 3476. The battery monitor/charger 3478 may be used to monitor other parameters of the battery 3476 to provide failure predictions, such as the state of health (SoH) and the state of function (SoF) of the battery 3476. The battery monitor/charger 3478 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 3478 may communicate the information on the battery 3476 to the processor 3452 over the interconnect 3456. The battery monitor/charger 3478 may also include an analog-to-digital (ADC) converter that enables the processor 3452 to directly monitor the voltage of the battery 3476 or the current flow from the battery 3476. The battery parameters may be used to determine actions that the edge computing node 3450 may perform, such as transmission frequency, mesh network operation, sensing frequency, and the like.

A power block 3480, or other power supply coupled to a grid, may be coupled with the battery monitor/charger 3478 to charge the battery 3476. In some examples, the power block 3480 may be replaced with a wireless power receiver to obtain the power wirelessly, for example, through a loop antenna in the edge computing node 3450. A wireless battery charging circuit, such as an LTC4020 chip from Linear Technologies of Milpitas, California, among others, may be included in the battery monitor/charger 3478. The specific charging circuits may be selected based on the size of the battery 3476, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 3458 may include instructions 3482 in the form of software, firmware, or hardware commands to implement the techniques described herein. Although such instructions 3482 are shown as code blocks included in the memory 3454 and the storage 3458, it may be understood that any of the code blocks may be replaced with hardwired circuits, for example, built into an application-specific integrated circuit (ASIC).

Also in a specific example, the instructions 3482 on the processor 3452 (separately, or in combination with the instructions 3482 of the machine readable medium 3460) may configure execution or operation of a trusted execution environment (TEE) 3495. In an example, the TEE 3495 operates as a protected area accessible to the processor 3452 for secure execution of instructions and secure access to data. Various implementations of the TEE 3495, and an accompanying secure area in the processor 3452 or the memory 3454 may be provided, for instance, through use of Intel® Software Guard Extensions (SGX), AMD® Secure Encrypted Virtualization (SEV), or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the edge computing node 3450 through the TEE 3495 and the processor 3452.

In an example, the instructions 3482 provided via memory 3454, the storage 3458, or the processor 3452 may be embodied as a non-transitory, machine-readable medium 3460 including code to direct the processor 3452 to perform electronic operations in the edge computing node 3450. The processor 3452 may access the non-transitory, machine-readable medium 3460 over the interconnect 3456. For instance, the non-transitory, machine-readable medium 3460 may be embodied by devices described for the storage 3458 or may include specific storage units such as optical disks, flash drives, or any number of other hardware devices. The non-transitory, machine-readable medium 3460 may include instructions to direct the processor 3452 to perform a specific sequence or flow of actions, for example, as described with respect to the flowchart(s) and block diagram(s) of operations and functionality depicted above. As used herein, the terms “machine-readable medium,” “computer-readable medium,” “machine-readable storage,” and “computer-readable storage” are interchangeable.

In an example embodiment, the edge computing node 3450 can be implemented using components/modules/blocks 3452-3486 which are configured as IP Blocks. An individual IP Block may contain a hardware RoT (e.g., device identifier composition engine, or DICE), where a DICE key may be used to identify and attest the IP Block firmware to a peer IP Block or remotely to one or more of components/modules/blocks 3462-3480. Thus, it will be understood that the node 3450 itself may be implemented as a SoC or standalone hardware package.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

The block diagrams of FIGS. 33 and 34 are intended to depict a high-level view of components of a device, subsystem, or arrangement of an edge computing node. However, it will be understood that some of the components shown may be omitted, additional components may be present, and a different arrangement of the components shown may occur in other implementations.

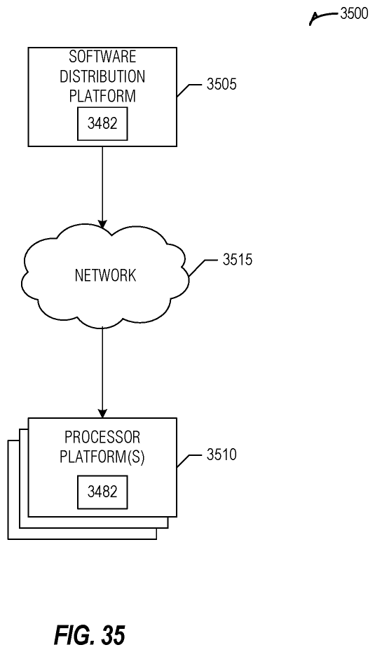

FIG. 35 illustrates an example software distribution platform 3505 to distribute software, such as the example computer readable instructions 3482 of FIG. 34, to one or more devices, such as example processor platform(s) 3510 and/or other example connected edge devices or systems discussed herein. The example software distribution platform 3505 may be implemented by any computer server, data facility, cloud service, etc., capable of storing and transmitting software to other computing devices. Example connected edge devices may be customers, clients, managing devices (e.g., servers), third parties (e.g., customers of an entity owning and/or operating the software distribution platform 3505). Example connected edge devices may operate in commercial and/or home automation environments. In some examples, a third party is a developer, a seller, and/or a licensor of software such as the example computer readable instructions 3482 of FIG. 34. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 35, the software distribution platform 3505 includes one or more servers and one or more storage devices that store the computer readable instructions 3482. The one or more servers of the example software distribution platform 3505 are in communication with a network 3515, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 3482 from the software distribution platform 3505. For example, the software, which may correspond to example computer readable instructions, may be downloaded to the example processor platform(s), which is/are to execute the computer readable instructions 3482. In some examples, one or more servers of the software distribution platform 3505 are communicatively connected to one or more security domains and/or security devices through which requests and transmissions of the example computer readable instructions 3482 must pass. In some examples, one or more servers of the software distribution platform 3505 periodically offer, transmit, and/or force updates to the software (e.g., the example computer readable instructions 3482 of FIG. 34) to ensure improvements, patches, updates, etc. are distributed and applied to the software at the end user devices.

In the illustrated example of FIG. 35, the computer readable instructions 3482 are stored on storage devices of the software distribution platform 3505 in a particular format. A format of computer readable instructions includes, but is not limited to a particular code language (e.g., Java, JavaScript, Python, C, C #, SQL, HTML, etc.), and/or a particular code state (e.g., uncompiled code (e.g., ASCII), interpreted code, linked code, executable code (e.g., a binary), etc.). In some examples, the computer readable instructions 3482 stored in the software distribution platform 3505 are in a first format when transmitted to the example processor platform(s) 3510. In some examples, the first format is an executable binary in which particular types of the processor platform(s) 3510 can execute. However, in some examples, the first format is uncompiled code that requires one or more preparation tasks to transform the first format to a second format to enable execution on the example processor platform(s) 3510. For instance, the receiving processor platform(s) 3500 may need to compile the computer readable instructions 3482 in the first format to generate executable code in a second format that is capable of being executed on the processor platform(s) 3410. In still other examples, the first format is interpreted code that, upon reaching the processor platform(s) 3510, is interpreted by an interpreter to facilitate execution of instructions.

Implementation of the preceding techniques may be accomplished through any number of specifications, configurations, or example deployments of hardware and software. It should be understood that the functional units or capabilities described in this specification may have been referred to or labeled as components or modules, to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field-programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center), than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions.

In the above Detailed Description, various features may be grouped to streamline the disclosure. However, claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment.

What is claimed is:

1. A compute node comprising:
a processing unit; and
memory including instructions for implementing a workload execution manager to manage a plurality of elastic workloads, the instructions, when executed by the processing unit, cause the processing unit to:
receive data describing a first elastic workload of the plurality of elastic workloads, the first elastic workload to execute on a first virtual execution environment, the first virtual execution environment associated with a first security context;
determine a common resource that is used by the plurality of elastic workloads;
store the common resource in a memory accessible by the first virtual execution environment; and
execute the first elastic workload, wherein the first elastic workload has access to the common resource, and wherein the plurality of elastic workloads is executed in isolation from one another based on respective security contexts.

2. The compute node of claim 1, wherein the first virtual execution environment includes a first virtual machine tenant.

3. The compute node of claim 1, wherein a second virtual execution environment is used to execute a second elastic workload, and includes a second virtual machine tenant.

4. The compute node of claim 3, wherein to determine the common resource, the compute node is to analyze first code of the first elastic workload and second code of the second elastic workload to identify a function reference that is common to both the first code and the second code.

5. The compute node of claim 4, wherein the function reference is a Named Function Networking (NFN) expression.

6. The compute node of claim 3, wherein to determine the common resource, the compute node is to analyze first code of the first elastic workload and second code of the second elastic workload to identify a data reference that is common to both the first code and the second code.

7. The compute node of claim 6, wherein the data reference is a Named Data Networking (NDN) expression.

8. The compute node of claim 3, wherein to execute the first elastic workload and the second elastic workload, the compute node is to alternate execution of the first and second elastic workloads.

9. The compute node of claim 1, wherein the common resource includes a function.

10. The compute node of claim 1, wherein the common resource includes a microservice.

11. The compute node of claim 1, wherein the common resource includes a library function.

12. The compute node of claim 1, wherein the common resource includes public data.

13. The compute node of claim 1, wherein the compute node is to:
update a security pointer from the first security context to a second security context, when executing the first elastic workload in the first security context to executing a second elastic workload in the second security context.

14. The compute node of claim 13, wherein the compute node is to:
clear cache lines of the first elastic workload before executing the second elastic workload, when switching from the first security context to the second security context.

15. The compute node of claim 1, wherein the compute node is to:
detect an application programming interface (API) call made by the first elastic workload, wherein the API is used to act on a resource, and wherein a parameter of the API call includes a token, the token including security, trust, or resiliency directives to apply to the resource; and
determine that the security, trust, or resiliency directives are satisfied before allowing the API call access to the resource.

16. The compute node of claim 1, wherein the compute node is to:
detect an application programming interface (API) call made by the first elastic workload, wherein the API is used to act on a resource, and wherein a parameter of the API call includes a service level agreement; and
determine that the service level agreement is satisfied before allowing the API call access to the resource.

17. A method performed by a computing device in a data center system, comprising:
receive data describing a first elastic workload to execute on a first virtual execution environment, and a second elastic workload to execute on a second virtual execution environment, the first and second virtual execution environments associated with respective first and second security contexts;
determine a common resource that is used by both the first elastic workload and the second elastic workload;
store the common resource in a memory accessible by both the first virtual execution environment and the second virtual execution environment; and
execute the first elastic workload and the second elastic workload, wherein each of the first elastic workload and second elastic workload have access to the common resource, and wherein the first elastic workload and second elastic workload are executed in isolation from one another based on the first and second security contexts.

18. The method of claim 17, wherein to determine the common resource, the computing device is to analyze first code of the first elastic workload and second code of the second elastic workload to identify a function reference that is common to both the first code and the second code.

19. At least one non-transitory machine-readable medium including instructions, which when executed by a computing device in a data center system, cause the computing device to:
receive data describing a first elastic workload to execute on a first virtual execution environment, and a second elastic workload to execute on a second virtual execution environment, the first and second virtual execution environments associated with respective first and second security contexts;
determine a common resource that is used by both the first elastic workload and the second elastic workload;
store the common resource in a memory accessible by both the first virtual execution environment and the second virtual execution environment; and
execute the first elastic workload and the second elastic workload, wherein each of the first elastic workload and second elastic workload have access to the common resource, and wherein the first elastic workload and second elastic workload are executed in isolation from one another based on the first and second security contexts.

20. The at least one non-transitory machine-readable medium of claim 19, wherein to execute the first elastic workload and the second elastic workload, the computing device is to alternate execution of the first and second elastic workloads.
